(19) United States
(12) Patent Application Publication
(10) Pub. No.: US 2008/0219804 A1
(43) Pub. Date: Sep. 11, 2008

(54) Container crane apparatus and method for container security screening during direct transshipment between transportation modes

(76) Inventor: Nigel Chattey, Irvington-on-Hudson, NY (US)

Correspondence Address: BRUCE L. ADAMS, ESQ.;ADAMS & WILKS, SUITE 1231, 17 BATTERY PLACE, NEW YORK, NY, 10004, US

(21) Appl. No.: 12/152,225

(22) Filed: May 12, 2008

Related U.S. Application Data
(63) Continuation-in-part of application No. 11/823,792, filed on Jun. 28, 2007, now Pat. No. 7,370,768.
Application No. 11/823,792 is a continuation of application No. 09/992,704, filed on Nov. 14, 2001, now abandoned.
(60) Provisional application No. 60/248,274, filed on Nov. 14, 2000.
(60) Provisional application No. 60/275,335, filed on Mar. 13, 2001.

(51) Int. Cl. B65G 67/60; G01M 19/00; G01N 23/00; B63B 27/12

(52) U.S. Cl. 414/140.3; 414/803; 212/325; 73/865.8; 378/57

(57) ABSTRACT

A crane apparatus installed on a pier, wharf, bulkhead wharf or other foundation directly transships containers from a vessel moored alongside the foundation to another transportation mode without ground placement of the containers. The crane apparatus includes a parent crane displaceable along the foundation for unloading containers from the vessel and placing them on a first platform of the parent crane, and a sibling crane displaceable along the foundation independently of displacement of the parent crane for loading containers from the first platform directly onto over-the-ground vehicles or onto another vessel moored alongside the foundation. The parent crane has a first trolley-hoist-spreader movable along an outreach boom for unloading containers from the vessel and placing them on either the first platform or a second platform of the parent crane, and a second trolley-hoist-spreader movable along a backreach boom for loading containers from the second platform onto another vessel or onto over-the-ground vehicles. A container security scanning system may be provided on the second platform for scanning the containers while on the second platform to determine whether one or more preselected chemical, biological, explosive or nuclear materials are present in the containers.

### CROSS REFERENCE TO RELATED APPLICATIONS

This application is a continuation-in-part of U.S. application Ser. No. 11/823,792 filed Jun. 28, 2007, which is a continuation of U.S. application Ser. No. 09/992,704 filed Nov. 14, 2001, which claims the benefit of provisional Application Nos. 60/248,274 filed Nov. 14, 2000 and 60/275,335 filed Mar. 13, 2001, which are hereby incorporated by reference, and priority thereto for common subject matter is hereby claimed.

### BACKGROUND OF THE INVENTION

The present invention relates generally to container cranes, and more particularly to a crane apparatus and method for directly transshipping containers between transportation modes without the need for placing the containers on the ground.

The volume of worldwide containerized cargo is increasing faster than is the capacity of many of the world's conventional marine container terminals. The problem is being compounded by a shortage of terminal space and increasing congestion caused by traditional, ship/stack/trailer-truck type operations. In addition, air pollution problems in and around marine terminals, most notably in older port cities such as New York, Los Angeles, Rotterdam and Hamburg, now dictate that major changes are needed in the method of handling marine container cargoes.

The primary reason these problems continue to increase can be attributed to one factor: The rapid increase in container vessel size, i.e., from 4,000 TEU (Panamax) to 12,000 TEU (Ultra Large Container Vessels—(ULCVs). This represents a capacity increase of 300% in less than twenty years.

A surge effect is caused by the large increase in the volume of containers having to be handled from an ULCV.

Additional real estate, needed to solve the resulting yard congestion, is seldom available, especially when terminals are located in densely populated port cities. At terminals where intermodal ship-to-truck transfers predominate, traffic congestion has resulted in having to increase stack areas. This, in turn, has resulted in the need for greater numbers of in-terminal yard equipment, e.g., diesel engine shuttle-carriers, rubber-tired gantries (RTGs), rail-mounted gantries (RMGs), yard tractors, top-picks, etc.

The resulting pollution problem is further aggravated by the number of road trailer-trucks that are forced to wait longer periods idling their engines, before they can pick-up or drop-off containers. In addition, vessels run their auxiliary engines while at dock in order to maintain on-board electric power further contributing to the pollution problem.

At the same time that terminal traffic congestion and pollution problems have been increasing, container security problems have also increased. Currently, only limited container scanning and screening is taking place and then only at terminal truck exit portals. This can result in a time delay of several days before even these few containers are scanned.

The net result of these increasing problems has been to reduce container terminal thruput rates. This, in turn, has limited the economies of scale achievable by the ULCVs. These large ships are having to spend an increased portion of their overall logistics time in port rather than at sea where they make money.

It is not a coincidence that Maersk Line, one of the most efficient long haul container shipping fleets in the world, has recently posted its first operating loss, in spite of the number of new ULCVs entering its service.

While congestion delays and pollution problems at many container terminals have increased severely over the past 20 years, solutions to these problems have been hard to realize, and are taking a long time, if ever, to implement.

For example:

1. On-dock, or near dock, rail facilities are proving difficult to locate in terminals where ship-to-truck operations predominate.

2. “Cold-ironing” onboard ULCVs, so they can shut down their diesel engines while in port, is proving costly and encountering delays in installation.

3. The attempts so far to increase the number of containers being scanned have failed for both operational and technical reasons.

One solution to mitigate these problems would come from logistics systems that enable the direct transshipment of containers between transportation modes, i.e., without the need for their ground placement before they leave the terminal. For example, direct transshipment between container ships and feeder vessels, barges, ferries, etc., and direct transshipment between container ships and container unit-trains.

Modern examples of port/rail container terminal facilities are those in Los Angeles (Pier 400 and the Alameda Rail Corridor Project) and ECT project at Maasvlacht. The ECT project is being linked to the Ruhr District in Germany by a new rail tunnel and railroad being constructed in connection with Deutsche Bahn.

Both these terminals, however, currently involve indirect ship to unit-train transshipment container logistics systems, i.e., the dockside cranes move the containers from the ship via one or more types of ground transportation units to a container stacking yard. Such ground transportation units are either manned (driver driven) or automated transfer systems. Examples are: Gaussin S. A.'s multi-trailer sets (MTS); BUISCAR's system; automated guided vehicles (AGVs) such as those of Siemens/Demag and, more recently, 1-over-1 shuttle straddle carriers such as those of Kalmar Industries. Because these transfer systems move the containers from dockside to intermediate container stacking areas within the marine terminal, they are classed as INDIRECT, as against DIRECT, transshipment systems.

Various types of mobile container lifting equipment, such as rubber-tired gantries (RTGs) or rail-mounted gantries (RMGs), then transfer the containers from these ground transportation systems and stack the containers in the terminal's stack, or storage, areas. Here the containers wait until a unit-train comes into, or nearby, the marine terminal, at which time various types of mobile container lifting equipment again lift the containers and load them onto the rail-cars. There are therefore a minimum of three handlings of the container in such an indirect “on-dock” rail transshipment logistics system. Often the need to sort containers between stacks can lead to a further two or three additional handlings of a container.

One recent advance has been to automate the container stacking/unstacking functions within the terminal. This is exemplified by the Hessenatie/Siemens/Demag overhead automated bridge crane stacking system that was tested in the Port of Antwerp and by the PSA automated terminal system in Singapore.

These systems, while certainly increasing container handling productivity within terminals, whether manned or automated, are still only component parts of indirect transshipment systems.

By contrast, DIRECT, as against INDIRECT, transshipment of containers between ship and other transportation modes (such as container feeder vessels, barges and/or container unit-trains and other over-the-ground equipment) requires that such multiple handling be avoided. This can only be done if the quayside container crane is designed to move the container to these other transportation modes directly, without the necessity of ground placement, thereby eliminating, to the maximum extent possible, the need for container stacking within the terminal.

In turn, this can only be done by a totally new system of container handling and logistics. Specifically by the use of multiple hoists (together with one or more platforms) within a “parent” quayside container crane. In addition, for the direct transshipment of containers between ship and container unit-trains and other over-the-ground equipment, an independent but associated “sibling” crane must work in conjunction with its parent quayside container crane.

Such a sibling crane must be able to move independently under and on either side of its parent crane. As such, by moving independently along the quay, or wharf, it can load rail-cars (or other over-the-ground equipment) even though its parent crane has to remain in a fixed position while unloading a particular cell of a container vessel.

The mobile parent quayside container cranes working in conjunction with their associated sibling cranes according to this invention, hereinafter sometimes referred to as the Poseidon™ crane system, achieve the direct transfer of containers between all these transportation modes without the necessity of ground placement, within the shortest possible cycle distance, and in the shortest possible cycle time.

The sibling cranes in this invention can be either rubber-tired gantry cranes (RTGs) or rail-mounted gantry cranes (RMGs). In practice, however, because of the narrow conditions, and for control and safety reasons, the optimal cranes to use should be RMGs.

Another major consideration is that, as the size and draft requirements of container vessels continue to increase, many relatively shallow ports are no longer able to receive such vessels. This is particularly true on the U.S. East and Gulf Coasts. The economies of scale achievable by the use of these larger ships, however, is forcing a dramatic change in planning for the future. The concept of centralized hub terminals, dedicated to a single shipping company or Alliance, and capable of taking the deepest draft container ships, which then transship containers to container unit-trains and/or to feeder vessels and/or barges for their movement to shallower ports, is now being actively explored by shipping companies, terminal companies and port authorities around the world. In the United States, this trend is exemplified by Maersk/Sealand's decision to possibly leave its major U.S. East Coast hub in the Port of New York/New Jersey for a deep-water, 568 acre, site they have purchased in Portsmouth, Va., a decision being forced by the multi-billion dollar cost of trying to deepen the channel to its existing facilities in Port Elizabeth, New Jersey.

As a result of these changes in marine container logistics systems, there is a parallel need being generated for new types of container handling and transshipping equipment. According to one aspect of this invention, a parent quayside container crane with its associated sibling crane is designed to enable the direct transshipment of marine containers without the necessity of ground placement. The invention is particularly useful for the direct transshipment of marine containers between container ships and (1) other marine modes such as feeder ships, barges, ferries, etc. and (2) over-the-ground vehicle modes including (a) railway modes, such as single-stack and double-stack container unit-trains, (b) all types of wheeled over-the-ground equipment, manned or automated, and (c) road trailer-trucks and multi-trailer sets.

According to another aspect of this invention, the parent quayside container crane may be a double broom crane having both an outreach boom and a backreach boom, which results in a more stable center of gravity that is particularly advantageous at longer outreaches such as needed for loading/unloading containers onto/from large-capacity modern-day container vessels, such as ULCVs.

The crane apparatus having cooperating parent and sibling cranes according to the present invention is designed to operate optimally on piers, including “J” “L” and “T” piers, wharves, bulkhead wharves, etc.

### SUMMARY OF THE INVENTION

One object of the present invention is to provide a crane apparatus and method for the direct transshipment of marine containers between transportation modes and which overcomes the aforementioned drawbacks associated with prior art crane systems.

A further object of the present invention is to provide a crane apparatus and method for the direct transshipment of marine containers between transportation modes with container security scanning and screening occurring during transshipment.

Another object of the present invention is to provide a crane apparatus and method that uses one or more sets of parent and sibling cranes operable in synchronization to effect transverse and longitudinal transshipment of containers between transportation modes without the necessity for ground placement of the containers.

A further object of the present invention is to provide a crane apparatus and method for the direct transshipment of marine containers between transportation modes and which has higher lift per hour rates of containers to or from a vessel than prior art crane systems.

Another object of the present invention is to provide a crane apparatus and method for the direct transshipment of marine containers between transportation modes using a double boom crane, the double boom crane being useable either with or without an associated sibling crane.

These as well as other objects, features and advantages of the invention are realized, in one aspect, by a crane apparatus having multiple hoists and container platforms within a parent crane and its independent, but associated, sibling crane that, as these cranes are operated in synchronization, allows for the transverse and longitudinal transshipment of containers between all transportation modes without the necessity of ground placement of the containers.

This system of multiple hoists and container platforms allows the parent crane to remain in any fixed position while unloading/loading a container ship as fast as possible, i.e., without having to be involved in numerous time-consuming, short distance, moves back and forth along the pier or wharf. The parent crane can remain in a fixed position as long as necessary, for example, in order to complete the unloading/loading cycle for any single cell on the container ship. It can remain in its fixed position whatever moves subsequently have to be made by the other modes in the overall transshipment cycle, i.e., specifically whatever moves have to be made by other marine vessels or by container unit-trains or by other over-the-ground vehicles.

The advantages of this direct transshipment system include the following:

1. Faster turn-around time for the container ship resulting from the high lift/hour rates of the parent cranes.

2. Direct loading of on-going land modes from the terminal, or in-coming land modes to the terminal, resulting in quicker turn-around times for such equipment.

3. Less dwell-time, and more secure dwell-time, of containers within the terminal.

4. Less overall lift and transfer cost of containers in and out of the terminal.

The foregoing as well as other objects, features and advantages of the invention are realized, in another aspect, by a crane apparatus having a double boom (DB) crane, which provides significant advantages over a single boom (SB) crane in reducing congestion and pollution problems, and container security problems, at container terminals. The single boom (SB) cranes, presently in use, cannot solve this constellation of problems. This can only be done by the introduction of double boom (DB) cranes.

SB cranes have an additional problem. As vessels have increased in size, they have increased in width. The Emma Maersk class (at 22 containers across) is twice as wide as the Panamax Class (at 11 containers across). The outreach of the SB crane has had to increase from 100 ft to 200 ft. As a result, the center of gravity of SB cranes has become precarious; as witnessed by the fact that five such cranes were blown over by high winds in Busan harbor.

DB cranes have both an outreach and a backreach boom. This results in a more stable center of gravity and allows them to operate at higher dynamic load levels than can SB cranes.

This disclosure describes the use of DB cranes in two illustrative embodiments:

First: In the direct transshipment of containers between vessel and rail-cars, and vise versa, without the need for ground placement of the containers.

Second: In the direct transshipment of containers between longhaul vessel and feeder vessel, and vise versa, also without the need for ground placement of the containers.

This invention thus strikes at the heart of the growing container congestion and associated pollution problems plaguing many container terminals today. This invention, in both illustrative embodiments, significantly shortens the distances and time cycle for a container before it is transshipped through the terminal and ongoing in the next transportation mode. DB cranes used in their direct transshipment modes can achieve these faster container cycling times as effectively for import containers as for export containers, i.e. their efficiency is the same for loading as for unloading a vessel.

One unique and additional aspect of both DB configurations is the installation of a deck at the gantry portal level of the cranes. In its simplest form, the portal level deck is the site for three or more buffer-slot platforms, which accommodate temporary delays in the handling and checking of any individual container, thus not slowing down the overall lift rate of the crane.

In its more complex configuration, the portal level deck is also the site for three or four container security scanning and screening systems. Installation of such container security scanning systems can involve gamma-ray, neutron, x-Ray or spectroscopic detection; or, in a more advanced configuration, can also involve total integrated CBENR scanning.

Importantly, scanning, under either configuration, is undertaken at the same time as trolley movements. As a result, there is no loss in a DB crane's overall container cycling time, even when integrated container scanning of all containers is included.

In fact, by DB cranes not having to lower or raise containers onto or from the wharf apron under the crane, the distance traveled by containers within such cranes is actually shortened, and faster cycle times can be achieved. With faster container cycle times, DB cranes, as exemplified in this disclosure, thus also shorten the long-haul turn-around-time of the vessel. This, in turn, reduces the ratio of voyage berth time to voyage sailing time and significantly improves the profitability of the ULCVs.

These advantages of the DB cranes can improve productivity, reduce costs, reduce pollution, reduce congestion and increase container security. These benefits can be achieved over the entire container logistics chain, especially if DB cranes are installed at major origin, destination and, as importantly, at major transshipment ports and terminals.

In addition, while benefiting port and terminal economics, DB cranes will also benefit vessel economics thus allowing shipping lines to realize their full economies of scale.

Finally, while DB cranes are more expensive than standard SB cranes, their major savings more than offset their increased cost. The use of DB cranes significantly reduces the number of terminal vehicles needed, i.e., RTGs, RMGs, straddle-carriers, yard-tractors, top-picks, etc. In addition, the size of container stacks within the terminals can be reduced as can the number of RTGs and/or RMGs involved in servicing the stacks. This large reduction in yard equipment and operators more than offsets the increase in DB crane related jobs.

The Poseidon™ crane system thus provides substantial cost savings to both container shipping companies and container terminal operators.

The foregoing as well as numerous other objects, features and advantages of the invention will become readily apparent to those of ordinary skill in the art upon a reading of the following detailed description of the invention when read in conjunction with the accompanying drawings.

### BRIEF DESCRIPTION OF THE DRAWINGS

FIG. 1 is an explanatory elevational view, partly in section, of one embodiment of a crane apparatus and method according to the present invention, showing a parent quayside container crane and its associated sibling rail-mounted gantry crane (RMG crane), both mobile on rails, mounted on a standard-type pier constructed, for example, on the slab, plinth and piling principle, and illustrating the manner in which these cranes are able to transship containers directly between various transportation modes without the necessity for ground placement of the containers.

FIG. 2 is an explanatory elevational view, partly in section, of another embodiment of a crane apparatus and method according to the present invention, showing the crane apparatus mounted on a standard-type pier and showing the transshipping of containers from a container vessel directly to other marine mode vessels such as, for example in this case, to a river/harbor barge or to a feeder vessel (or, as is more likely in the United States, a coastal tug-barge system), without the need for ground placement of the containers.

FIG. 3 is an explanatory elevational view, partly in section, of another embodiment of a crane apparatus and method according to the present invention, showing the crane apparatus mounted on a standard-type pier and showing the transshipping of containers from a container vessel directly to the railway mode such as, for example in this case, to single-stack and double-stack rail-cars comprising cuts of container unit-trains standing on the pier on railway tracks immediately under the cranes, again without the need for ground placement of the containers.

FIG. 3a is an enlarged view of part of the crane apparatus of FIG. 3 showing the unloading/loading cycle of the sibling crane.

FIG. 4 is an explanatory plan view of a container ship alongside a pier, illustrating the manner in which several parent quayside container cranes directly transship containers to rail-cars on the pier.

FIG. 5 is an explanatory elevational view, partly in section, of another embodiment of a crane apparatus and method according to the present invention, showing the crane apparatus mounted on a standard-type pier and showing the transshipping of containers from a container vessel directly to over-the-ground equipment, such as, for example in this case, directly to manned, or automated, multi-trailer sets (MTS) and/or automated guided vehicles (AGVs) and/or trailer-trucks standing on the pier immediately under the cranes, and again all without the need for ground placement of the containers.

FIG. 5a is an enlarged view of part of the crane apparatus of FIG. 5 showing the unloading/loading cycle of the sibling crane.

FIG. 6 is an explanatory elevational view, partly in section, of another embodiment of a crane apparatus and method according to the present invention, showing the crane apparatus mounted on a standard-type pier and showing the transshipping of hatch covers from a container vessel directly to a hatch-cover platform within the parent quayside container crane without the necessity for ground placement of the hatch covers.

FIG. 7 is an explanatory elevational view, partly in section, of another embodiment of a crane apparatus and method according to the present invention, showing the crane apparatus mounted on a caisson and illustrating the transshipping of containers between all the modes illustrated in FIG. 1 as well as the direct transshipment between each mode individually, as illustrated in FIGS. 2 through 5.

FIGS. 8 through 10 are explanatory elevational views, partly in section, of other embodiments of crane apparatus and methods according to the present invention, showing the crane apparatus mounted on different support structures or foundations.

FIG. 11 is an explanatory elevational view, partly in section, of a further embodiment of a crane apparatus and method according to the present invention, showing a smaller version of crane apparatus and showing the transshipping of containers from a container barge directly to the railway mode such as, for example in this case, to single-stack and double-stack rail-cars without the necessity for ground placement of the containers.

FIGS. 12a-12c illustrate one example of a machine trolley-hoist-spreader displaceable lengthwise and widthwise along a boom of the crane apparatus, FIG. 12a being a plan view, FIG. 12b being a cross-sectional view taken along line 12b-12b of FIG. 12a, and FIG. 12c being a cross-sectional view taken along line 12c-12c of FIG. 12b.

FIG. 13a is a side elevational view, partly in section, of a DB crane installed on a wharf for the direct transshipment of containers between vessels and container railcars, and vise versa, without the need for ground placement of the containers.

FIG. 13b is a plan view, and FIGS. 13c and 13d, respectively, are cross-section elevational views taken along the lines A-A and B-B in FIG. 13(a) through the outreach boom and backreach boom of the DB crane.

FIG. 14 is an explanatory plan view of a container terminal wharf showing eight DB cranes unloading/loading containers directly between a ULCV and unit-train cuts of container rail cars. A cutaway in FIG. 14 shows the sibling cranes used in these transfers and which eliminate the necessity of ground placement of said the containers.

FIG. 15 is a plan view of a standard container terminal where ship-to-stack and stack-to-truck and stack-to-off-dock rail are the primary container logistics functions.

FIG. 16a is a side elevational view, partly in section, of a DB crane installed on a pier for the direct transshipment of containers between large vessels and smaller feeder vessels, and vise versa, without the need for ground placement of the containers.

FIG. 16b is a plan view and FIGS. 16c and 16d, respectively, are cross-section elevational views taken along lines A-A and B-B in FIG. 16(a) through the outreach boom and backreach boom of the DB crane.

FIG. 17a is a plan view of a smaller (4000 TEU) feeder vessel.

FIG. 17b is a plan view of a ULCV (12,000 TEU) vessel.

FIG. 17c is a plan view of a container terminal pier in which eight DB cranes are directly unloading/loading, across the pier, containers between the ULCV and feeder vessels, and vise versa, without the need for ground placement of the containers.

FIGS. 18a, 18b and 18c are, respectively, cross-sectional views and a plan view of the trolley-hoist-spreader on the outreach boom of all the DB cranes.

FIGS. 19a, 19b, 19d and 19e are cross-sectional views, and FIG. 19c is a plan view, of the trolley-hoist-spreader on the backreach boom of the DB crane designed for direct transshipment of containers between vessels without the need for ground placement of these containers.

FIGS. 20a, and 20c are cross-sectional views and 20b is a plan view of the integrated container security scanning system for integrated Chemical, Biological, Explosive and Nuclear (CBEN) scanning of all containers that can be installed at the gantry portal level of all the DB cranes.

FIG. 21 is a plan view of an intermodal container terminal utilizing double boom DB and single boom SB cranes for direct transfer of containers between different transportation modes.

### DETAILED DESCRIPTION OF THE INVENTION

The present invention relates to crane apparatus and methods for effecting the direct transshipment of containers between transportation modes without the need for placing the containers on the ground. The crane apparatus comprises one or more sets of parent and sibling cranes, which are movable independently of one another, in synchronization, to directly transship containers between transportation modes. For ease of description, the embodiments of the invention described hereinafter show only one set of parent and sibling cranes, it being understood that in practice there will be two, three, four or more sets of parent and sibling cranes operating at the same time, depending on the size and type of container vessel being loaded/unloaded. Throughout the drawings, the same or like elements are denoted by the same reference characters.

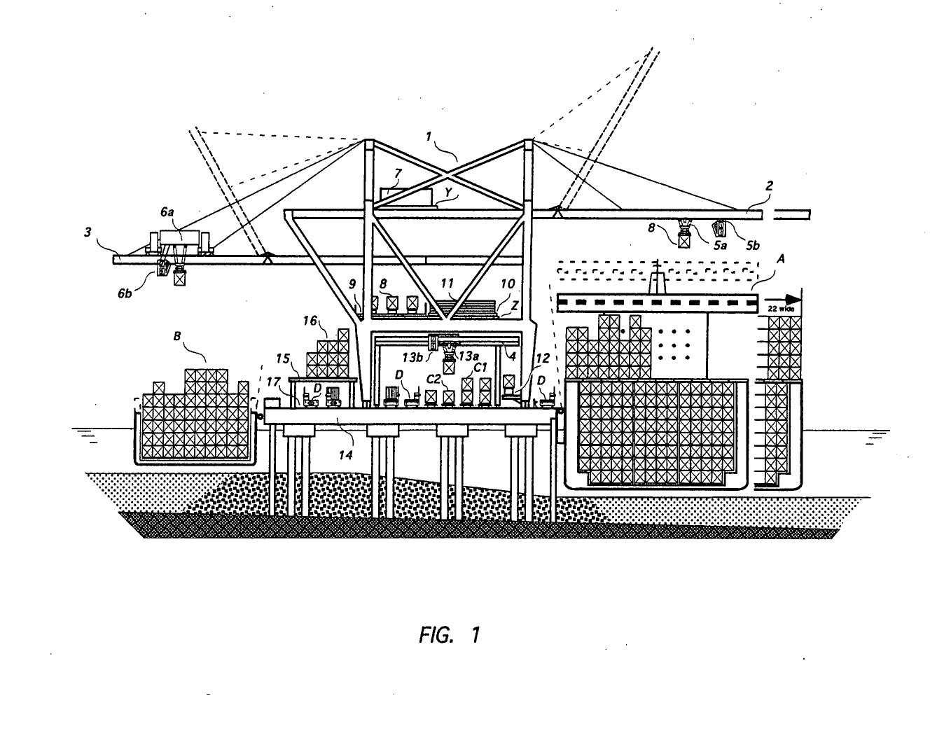

One embodiment of the invention is illustrated in FIG. 1, which shows crane apparatus comprising a parent quayside container crane 1 together with its associated sibling RMG crane 4, both of which are movable on ground level trackways such as rails along a pier 14. As explained hereinafter, the parent crane 1 cooperates with the sibling crane 4 to effect the direct transshipment of containers 8 between container ships A (of whatever size and beam) and (1) other marine modes B, such as river/harbor barges or feeder vessels (or, as is more likely in the United States, coastal tug-barge systems); and/or (2) over-the-ground vehicles, such as double-stack rail cars C1 and single stack rail-cars C2; and/or (3) other modes of over-the-ground equipment, such as yard tractors D.

As shown in FIG. 1, the mobile parent quayside container crane 1 has two crane booms 2 and 3 placed on opposing sides thereof and built into, and part of, its overall structure. The boom 2 carries a rope trolley-hoist-spreader 5a (or alternatively a machine trolley) and an independently mounted operator control cabin 5b. The boom 3 carries a machine trolley-hoist-spreader 6a and an independently mounted operator control cabin 6b. At least two platform bearing structures Y and Z are built into the overall structure of the mobile parent quayside container crane 1. If the boom 2 carries a rope trolley-hoist-spreader, then a rope trolley-hoist driving motor and winch room 7 is located on the platform bearing structure Y. A fixed platform 9 for receiving containers 8 and a fixed platform 10 for receiving hatch covers 11 are both located on the platform bearing structure Z. The fixed platform 9 is designed to enable twist-lock crews to unlock, and lock, the twist-locks on the containers 8 when necessary.

The parent quayside container crane 1, which is displaceable lengthwise along the pier on its own ground level rails, has associated with it the sibling rail-mounted gantry crane (RMG) 4, which is independently displaceable lengthwise along the pier 14 on its own ground level rails. The sibling RMG crane 4 is capable of operating under, and in conjunction with, the parent crane 1, but independently of it, for a given distance on either side of the parent crane, without interfering with the other parent quayside container cranes 1 and their sibling RMG cranes 4 (not shown) as they may also be operating on either side along the same pier 14.

The sibling RMG crane 4 is mounted on its own set of rails, independent of the rails upon which the mobile parent quayside container crane 1 is mounted. As such, the sibling RMG crane 4 can travel back and forth along the pier 14, under any position of its mobile parent crane 1 as, for example, while the parent crane 1 is in a fixed position unloading or loading a particular cell of a container ship. The actual distance that the sibling RMG crane 4 can travel along the pier 14, under and on either side of its parent crane 1, when the crane 1 is in a fixed position, however, is determined by the distance that similar sibling RMG cranes 4 are also working along the same pier 14 on either side under their respective parent cranes 1.

The parent crane 1 has a fixed receiving platform 12 for containers 8 on one side of, and fixed to the structure of, the crane 1. The platform 12 is designed to enable twist-lock crews to unlock and lock the twist-locks on the containers 8 when necessary.

The sibling RMG crane 4 has working within it, and operating at right angles to the rail-mounted movement of the crane 4 along the pier 14, a trolley-hoist-spreader 13a and an operator control cabin 13b.

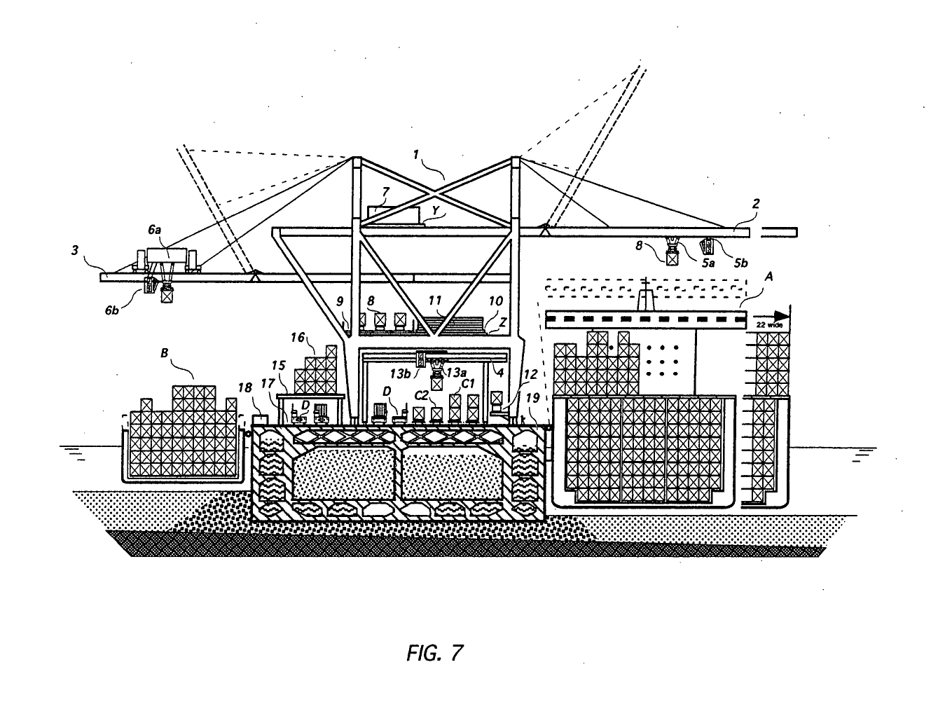

Each mobile parent crane 1, and each mobile sibling RMG crane 4 associated with it, together with their rails and power systems, are capable of being mounted on piers, either standard type piers, for example, of the slab, plinth and piling type 14 as shown in FIG. 1, or caisson piers 19, as shown in FIG. 7.

In this embodiment of the invention, and in order to lessen the width, and therefore the capital investment cost, of the pier 14, it is preferable to construct a raised platform 15 along the pier on which can be placed containers 16 awaiting re-stow aboard the container ship A. The raised platform 15 not only shortens the cycle time for such re-stowing of containers 16 but also creates a transportation corridor 17 (under the platform 15) for use by over-the-ground vehicles, such as yard-tractors D, etc.

It should be noted that the raised platform 15 is a stand-alone fixed structure running along the pier 14, and is in no way connected to the mobile parent cranes 1 or the mobile sibling RMG cranes 4 which must be free to move past the platform 15, up and down the pier 14.

FIG. 1 shows an embodiment of the invention in which the mobile parent cranes 1 and their mobile sibling RMG cranes 4 are mounted on and displaceable lengthwise along rails on a pier 14. Alternatively, as shown in FIG. 7, the mobile parent cranes 1 and their mobile sibling RMG cranes 4 can be mounted on trackways on a wharf, or a bulkhead wharf, built either by conventional methods or again, as constructed by caissons 19.

When the Poseidon™ crane system of the invention is placed on a wharf or bulkhead wharf, the option is available as to whether the raised platform 15, and the over-the-ground vehicle transportation corridor 17 that is under it, should or should not be constructed. This decision will depend on the layout of the backland of the terminal. If sufficient space is available, then containers 16, awaiting restowing aboard the container vessel A, can be stacked on the ground by the machine trolley-hoist-spreader 6a on the boom 3, and the transportation corridor 17 can be located landside of the restow stacks.

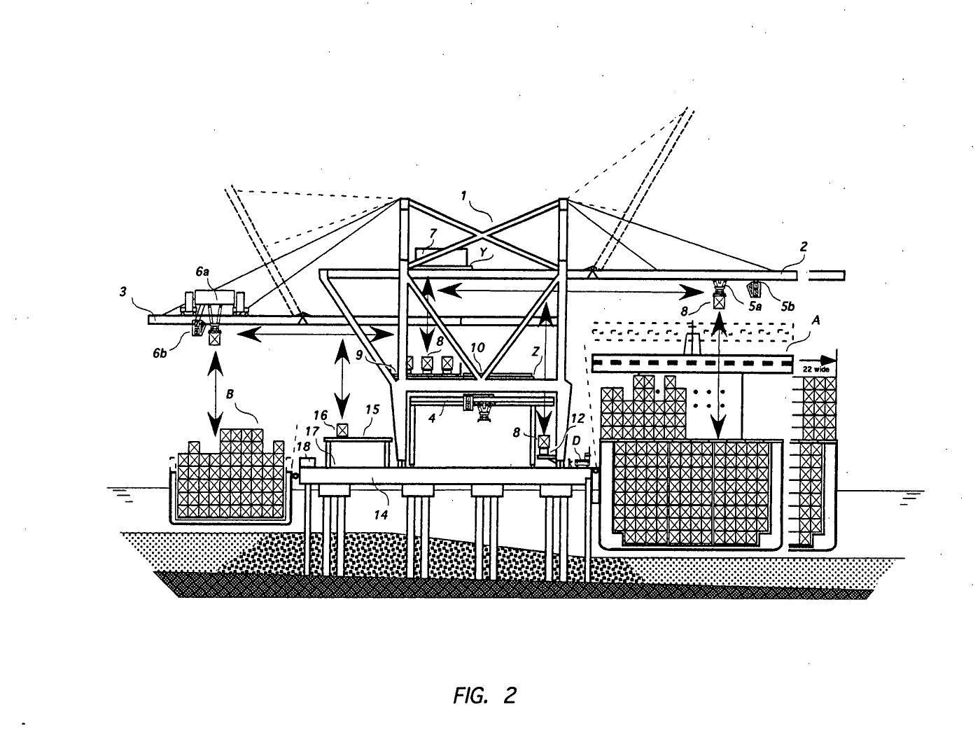

FIG. 2 illustrates an embodiment of the crane apparatus of the invention used to directly transship containers 8 across a pier 14, between a container ship A and other marine modes B, such as river/harbor barges, ferries, etc., and for example specifically in this case, to a container feeder vessel (or, as is more likely in the United States, to a coastal container tug-barge system).

The cycle time for unloading a container is made up of basically two movements, vertical and horizontal. Over the same travel distance, and when acceleration and de-acceleration times are taken into account, vertical movements of containers take approximately twice as long as horizontal movements.

As container ships have increased in size, the vertical movements over which a container has to move have also increased. When working such large vessels, the cycle time of single-hoist dock-side container cranes is now too long, i.e., at between 120 and 150 seconds on average in the United States.

If the cycle time is to be shortened, multiple hoists must cycle concurrently within the crane and, as importantly, these multiple hoists must operate with platforms within the crane. For example, in FIG. 2 are shown fixed container platforms 9, 10 and 12 constructed as integral structural parts of the mobile parent crane 1.

The overall cycle time for transshipping a container 8 is shortened by the fact that the first trolley-hoist-spreader 5a on the boom 2 has only to move the container 8 out of the ship A to the platform 9, high up in the crane, or to the platform 12 which is close to the dock-front. In either case the travel distance for containers is considerably shortened when compared to the distance that containers would have to travel within single-hoist cranes of similar outreach.

From the platform 9, the machine trolley-hoist-spreader 6a on the boom 3 only has to move either (1) a container 8 to the marine vessel B moored on the inside face of the pier, or (2) a container 16 to the re-stow stacking platform 15 (which is immediately adjacent to the back legs of the mobile parent cranes 1). Either of these movements is undertaken while the first trolley-hoist-spreader Sa on the boom 2 is returning to lift another container 8 from the container ship A.

From the platform 12, as shown in FIG. 1, the trolley-hoist-spreader 13a in the sibling RMG crane 4 only has to move the container 8 either (1) to rail-cars C1 or C2 on the rails running under both cranes, or (2) to other over-the-ground vehicles D, similarly positioned under both cranes. Again, either of these movements can be undertaken at the same time the first trolley-hoist-spreader 5a on the boom 2 is returning to lift another container 8 from the container ship A.

When the Poseidon™ crane system of FIG. 1 is operating under conditions of maximum synchronization, the cycle time in transshipping containers should be as low as 50 seconds, i.e, less than half the time achievable by even state-of-the-art single-hoist quayside gantry cranes, such as those now being built in China by ZPMC.

A more detailed description of the movements of the containers within the cranes 1 and 4 will be given with reference to FIG. 2, which shows the loading and unloading sequence of containers between container ship A and other marine vessels B.

The trolley-hoist-spreader 5a on the boom 2, under the control of an operator stationed in the independently mounted operator control cabin 5a, lifts the container 8 from the container ship A and transfers it to the fixed container receiving platform 9. On release of the container 8 at the fixed container receiving platform 9, the trolley-hoist-spreader 5a can immediately return to lift another container 8 from the ship A.

As soon as the trolley-hoist-spreader 5a on the boom 2 has cleared the fixed container receiving platform 9, the machine trolley-hoist-spreader 6a on the boom 3, under control of an operator stationed in the independently mounted operator control cabin 6b, lifts the container 8 off the fixed container receiving platform 9 and transfers the container 8 to either the marine vessel B moored on the inside face of the pier 14 or to the re-stow stacking platform 15 as a re-stow container 16 for subsequent return of the re-stow container 16 to the platform 9, and from there back into the container ship A by the trolley-hoist-spreader 5a on the boom 2.

The combination of the two trolley-hoist-spreaders 5a, 6a working in concert under the above-described sequence indicates that the mobile parent quayside container crane 1, when transshipping containers 8 between a container ship A and vessels B (such as river/harbor barges, container feeder vessels, or a coastal tug-barge system) should achieve a sustained lift rate in excess of 60 lifts an hour. For comparison purposes, 30 lifts an hour is considered an efficient sustained rate in the United States with single-hoist quayside container cranes.

The importance of this increase in lift rate, and decrease in cycle time, in transshipping containers is of considerable economic and operational importance, especially as these relate to the time taken in the management of the overall supply chain. For example, deployment of a Maersk Class “5” or “K”, nominally rated 6,800 TEU capacity, container ship between Kaohsiung, Taiwan and the Port of New York, could see unloading/loading the entire nominal cargo of 13,600 containers of this vessel in 48 hours or less, as against 96 hours with standard single trolley-hoist-spreader cranes.

For a given annual supply chain volume of 500,000 containers or more a year, the savings in this example, in port time each voyage, can result in being able to eliminate one entire vessel in the supply chain. At a $100+ million capital cost per vessel, in addition to ship crew costs, fuel costs, port fees, etc., the economic and operational incentives to convert to multiple hoist cranes according to the present invention becomes very real.

An additional, and important, consideration has to be taken into account. The initial position of the mobile parent cranes 1 over respective cells in the container ship A is not necessarily in alignment with the container cells in container feeder vessels or coastal tug-barge systems B moored on the other side of the pier 14. If misalignment is under 2.5 feet or 0.75 meters on either side, a standard trolley-hoist-spreader can be designed to adjust for such transverse distances. When misalignment is greater than 2.5 feet or 0.75 meters in either direction, additional alternatives have to be considered:

1. As container feeder vessels become larger (they are already at 1,200 TEU capacity in the Far East), and coastal tug-barge systems become larger (they are already at 800 TEU capacity in the United States), one alternative that can be considered is a system of “warping mules”. Warping mules have been used since the early 1900's on the Panama Canal. Modern warping mules can be installed along the side of the pier 14. It is now well within the state-of-the art to design warping mules capable of moving, and aligning, even the largest container feeder vessels or coastal tug-barge systems B.

2. A second alternative to be considered is to design the cells of the feeder vessel or coastal tug-barge system with the same horizontal clearance distances between cells as those on the container ship A. Once such a feeder vessel or coastal barge is securely moored at the right place on the side of pier 14, its cells, and those of the container ship A on the opposite side of pier 14, will be in alignment. All mobile parent quayside container cranes 1 working the container ship A will then be in direct alignment with the cells on the feeder vessel or coastal tug-barge systems B. The problem here, however, is that the number of containers coming out of a single cell of a large container ship A greatly exceeds the number of containers that a single cell can accommodate on a feeder vessel or tug-barge system B. Therefore moving the smaller vessels along the pier will still be required.

3. In order to minimize the number of movements feeder vessels or tug-barges have to make, another alternative can be considered: In FIGS. 1 and 2, it will be noted that the trolley-hoist-spreader 5a on the boom 2 has to be able to drop (and raise) containers 8 onto (and from) the platform 9 on the bearing platform Z. Similarly, the trolley-hoist-spreader 5a has to be enabled to drop (and raise) container vessel hatch covers 11 onto (and from) the platform 10 also on the bearing platform Z. It will be noted also that the boom 3, supporting its trolley-hoist-spreader 6a, lies above the bearing platform Z. In other words, the containers 8 and the hatch covers 11 have to pass through the boom 3 and its supporting structure. This, in turn, requires that the boom 3 be wide enough to accommodate such passages through it by the containers 8 and the hatch covers 11. However, the necessity of having to provide a much greater width in the boom 3, as against the boom 2, presents an opportunity to solve the misalignment problem referred to previously.

The optimum solution to the problem of misalignment between cells on either side of the pier 14 comes from making the width of the boom 3 wide enough to accommodate the machine trolley-hoist-spreader 6a. Specifically, the boom 3 should be wide enough to accommodate a machine trolley-hoist-spreader 6a capable of moving the containers 8 both in a transverse direction across the axis of the pier 14, and also longitudinally (parallel) to the axis of pier the 14. A further design option, inherent in this invention, is to make the longitudinal traverse of the machine trolley-hoist-spreader 6a capable of loading/unloading containers 8 to/from two adjacent cells of the feeder vessels or tug-barge systems B.

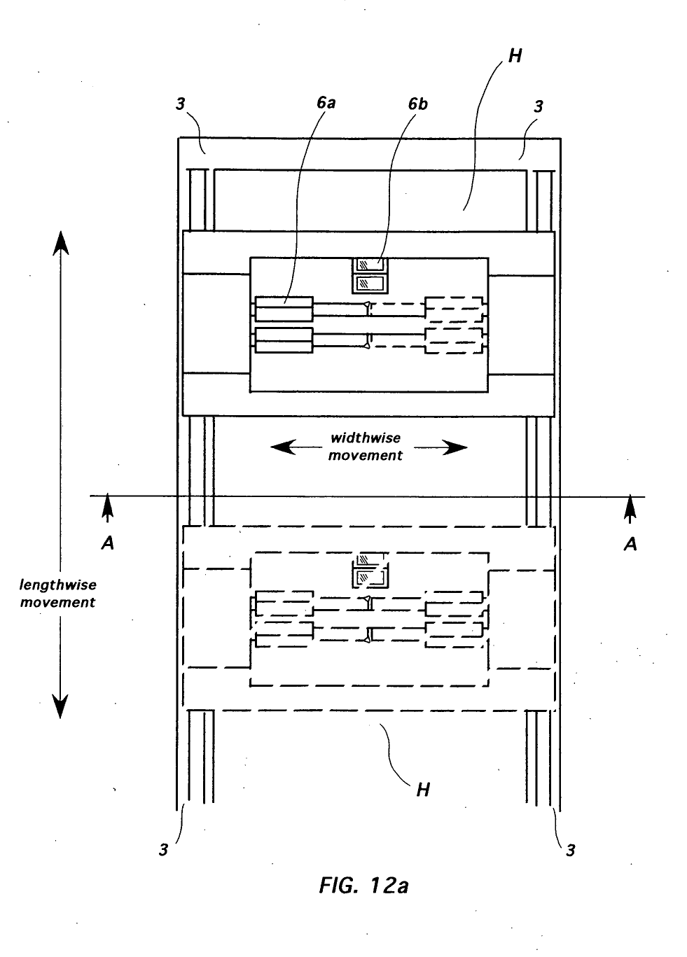

One example of such a machine trolley-hoist-spreader 6a capable of moving the containers 8 both in a transverse direction across the axis of the pier 14 and in a longitudinal direction along the axis of the pier is shown in FIGS. 12a-12c. The machine trolley-hoist-spreader 6a and the operator control cabin 6b constitute a machine H mounted to run on rails lengthwise along girders of the boom 3. The girders of the boom 3 are spaced wide enough apart to enable the trolley-hoist-spreader 6a to undergo limited movement on the machine H between the girders. The displacement of the trolley-hoist-spreader 6a in lengthwise and widthwise directions of the boom 3, i.e., transversely across the axis of the pier 14 and longitudinally along the axis of the pier, is controlled by an operator stationed in the operator control cabin 6b.

As shown in FIGS. 1 and 2, these exemplary embodiments of the invention, from a terminal operations standpoint, makes practical, and cost-efficient, the direct transshipment of containers between container ships and other marine vessels moored on opposing sides of a pier and, more specifically, by enabling this function to be undertaken without the necessity of ground placement of any of the containers being transshipped.

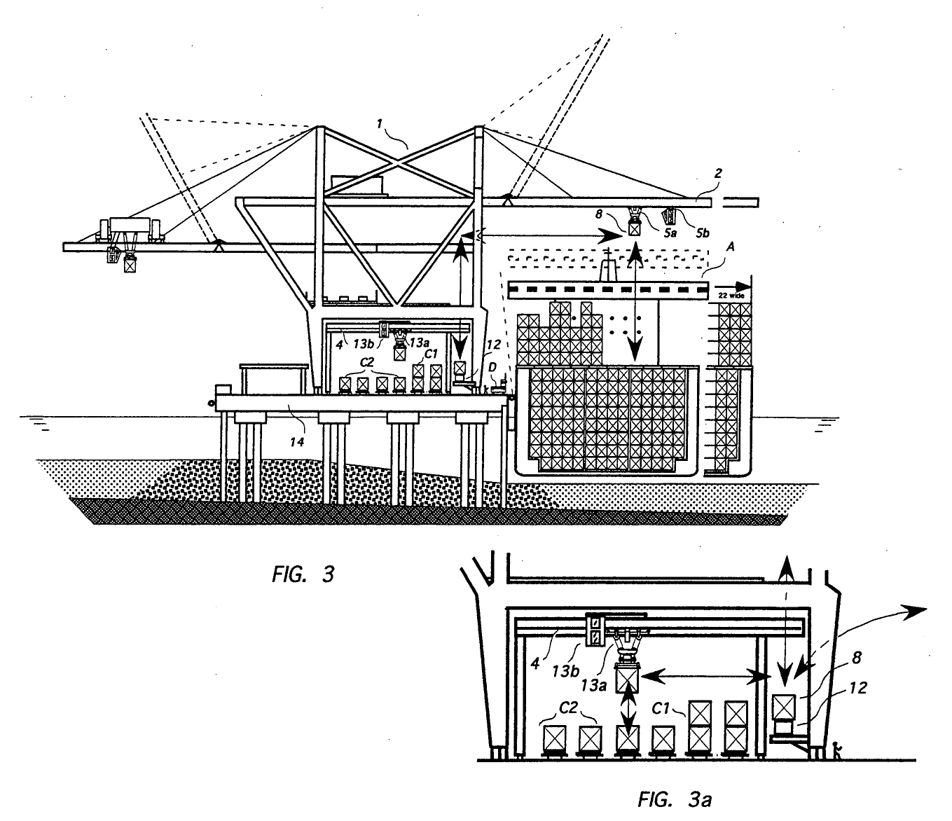

FIGS. 3 and 3a illustrate an embodiment of the crane system of the invention whereby mobile parent quayside container cranes 1 and their sibling RMG cranes 4 transship containers 8 between a container ship A and railway modes, for example, between the container ship A and double-stack container rail-cars C1, and/or single-stack container rail-cars C2. The rail-cars, in both instances, form cuts of container unit-trains standing on the pier 14 immediately under the mobile parent quayside container cranes 1 and their sibling RMG cranes 4.

In this illustrative embodiment of the invention, part of the container unloading/loading cycle is shown in FIG. 3, i.e., the trolley-hoist-spreader 5a under the control of an operator stationed in the independently mounted operator control cabin 5b lifts the container 8 from the container-ship A and transfers it to the fixed container receiving platform 12. The platform 12 is an integral structural part of the mobile parent quayside container crane 1 and is attached to the legs of the crane 1 at the ship side thereof.

The on-going part of the unloading/loading cycle is shown in the enlarged view of FIG. 3a. The trolley-hoist-spreader 13a mounted on the sibling RMG crane 4 lifts the container 8 from the container receiving platform 12 and transfers it to one of the double-stack C1, or single-stack C2, container rail-cars comprising cuts of container unit-trains on the pier 14 immediately under the cranes.

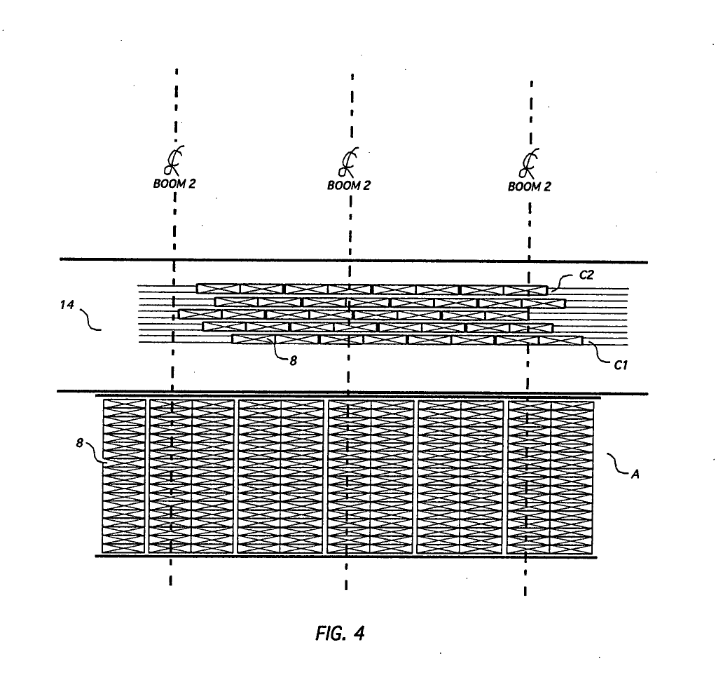

The reason that only an independent sibling RMG crane 4 can properly execute this last transfer now becomes apparent and will be explained with reference to FIG. 4. FIG. 4, which is a plan view of the pier 14, shows a number of mobile parent quayside container crane booms 2 working to unload a container ship A and also shows, for example, five parallel rail tracks aligned under the cranes along the pier 14. On these five rail tracks, however, the position of individual rail-cars, either double-stack C1 or single-stack C2, can be out of alignment with the mobile parent cranes 1 and the booms 2 and also out of alignment with any single position of the sibling RMG cranes 4.

More specifically, as shown in FIG. 4, the booms 2 of the parent quayside container cranes 1 are shown aligned over the container cells of the ship A. At the same time, however, the crane booms 2 are seen to be out of direct alignment with the rail-cars C1 or C2 on the pier 14—especially when these rail-cars, as shown, comprise different cuts of container unit-trains. Because of this misalignment, the direct loading of rail-cars by parent quayside cranes 1 (without the necessity of ground placement) can only be achieved if these cranes were to make continuous movements back and forth along the dock. This explains why a sibling RMG crane 4 (associated with its parent quayside crane 1) and able to move longitudinally up and down the dock, is needed if such continuous, and uneconomic, short movements by parent quayside cranes are to be eliminated.

For this reason, only the independent sibling RMG cranes 4 have the full longitudinal and transversal range to reach all drop-off positions under their parent cranes 1. By their independence, the sibling RMG cranes 4 can transfer the containers 8 longitudinally, and transversally, along and across the pier 14 to any position of the rail-cars C1 or C2, independently of any fixed position of their parent cranes 1.

The sibling RMG cranes 4 operating from under, and out to the sides of, their mobile parent quayside container cranes 1, however, must be controllable so that they do not collide with either containers 8 being lowered to (or raised from) the platform 12 by their parent cranes 1 or other sibling RMG cranes 4 working under, and out to the sides of, their mobile parent quayside container cranes 1. This can be achieved by standard state-of-the-art automated control systems controlling the position of each sibling RMG crane 4 as it must relate to the position of its parent crane and the cranes 1 and 4 on either side of it.

From an operational standpoint, the following trend in container terminal logistics is important. Specifically, as container ships continue to increase in size, the need also increases to unload and load these vessels as quickly as possible. Direct loading of containers onto other modes is the most efficient and cost-effective way to do this. However such direct loading dictates that each on-going mode is loaded randomly. For example, all rail-bound containers should be loaded randomly, and as quickly as possible, on any available vacant rail-car immediately under the cranes. Sorting by ultimate rail destination should not be attempted at the dock-side. Once cuts of rail-car unit trains are loaded they should be moved as quickly as possible to a point within, or near, the terminal, where the cuts can be formed into container unit-trains. Once these unit-trains are formed, they should be moved, also as quickly as possible, away from the terminal area to the nearest interior marshalling yard. It is at these key interior marshalling yards that consolidation of the containers by ultimate rail destination should take place.

At least five of the world's largest container ports are already building rail systems back from their main container terminals to achieve essential parts of the needed new ship-to-rail container logistics systems—Rotterdam and Antwerp in Europe, Los Angeles and Long Beach in the United States and Deltaport (Vancouver) in Canada. The drive to do this is coming largely from the increasing truck congestion in and around these port cities. These new rail systems are multi-billion dollar investments, as attested to by the Alameda Rail Corridor Project in California at $2.0 billion, and the equally ambitious Deutsche Bahn rail line and tunnels being built to connect the Ruhr with the Port of Rotterdam via the interior container marshalling yard at Barendrecht in the Netherlands.

Once these, and similar, rail systems are completed, the only missing link will be to provide the direct loading and unloading of containers to and from cuts of rail-car unit-trains positioned immediately under the dockside cranes. An object of the present invention to provide this essential final link in the new container supply-chain logistics systems that, of necessity, are having to be developed.

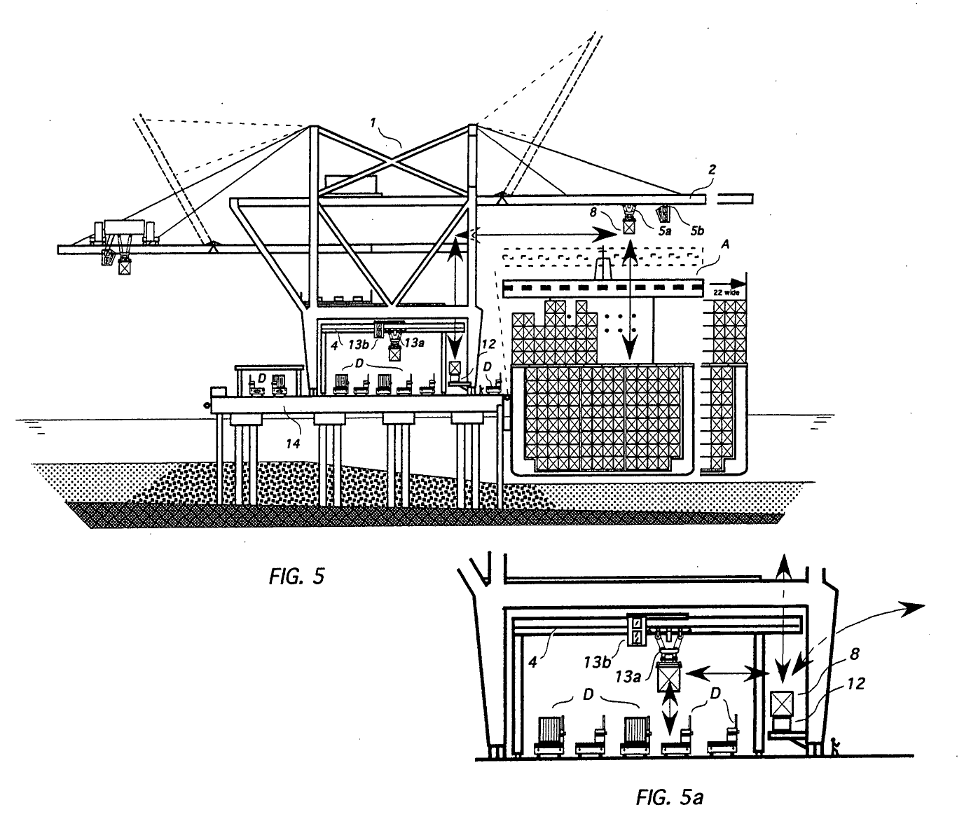

FIGS. 5 and 5a illustrate an embodiment of the crane apparatus and method of the invention used to directly transship containers 8 between a container ship A and over-the-ground transfer equipment D such as, for example, multi-trailer-sets (MTS), automated guided vehicles (AGVs), single-container rapid transfer units, and/or trailer-trucks. In this embodiment, the start of the unloading cycle shown in FIG. 5 is the same as shown in FIG. 3., i.e., the trolley-hoist-spreader 5a on the boom 2, under the control of an operator stationed in the independently mounted operator control cabin 5b, lifts the container 8 from the container ship A and transfers it to the fixed container receiving platform 12.

The on-going part of the unloading/loading cycle is shown in the enlarged view of FIG. 5a. In the case of trailer-trucks D, these can be driven, as is normal practice in marine container terminals, so that their trailers are aligned directly under the sibling RMG cranes 4. Under these conditions, the trolley-hoist-spreaders 13a, under the control of operators in the independently mounted operator control cabins 13b, can directly load the trailer-trucks D without necessarily having to move the sibling RMG cranes 4. The same can be said for AGVs or other single container, rapid transfer, units which can also be automatically located under the sibling RMG cranes 4, by the use of standard state-of-the-art automated control stops fed into their power drives.

With multi-trailer sets (MTS), and similar articulated, five or more, terminal wagon transfer systems, these can be randomly parked, within limits, under the cranes. Even if the MTS are randomly parked under the parent quayside container cranes 1, their sibling RMG cranes 4, being independently rail mounted, can accurately position the containers 8 on any individual empty wagon. This is because, as stated previously, the trolley-hoist-spreaders 13a of the cranes 4 are able to move in both a transverse and longitudinal direction over pier the 14.

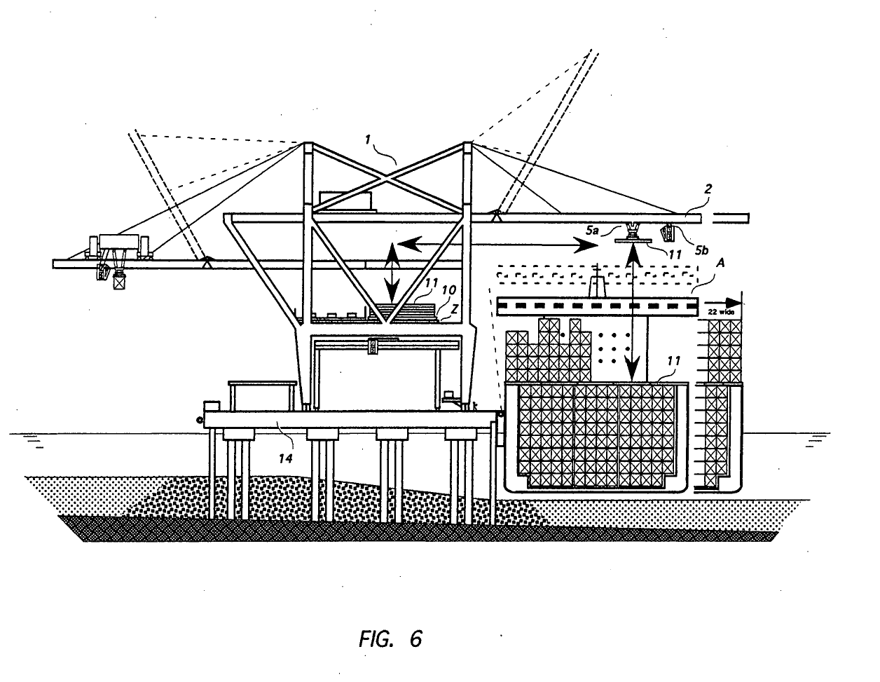

FIG. 6 illustrates an embodiment of the crane apparatus invention wherein the hatch covers 11 of the container ship A can be lifted by the trolley-hoist-spreader 5a on the boom 2, under the control of an operator stationed in the independently mounted operator control cabin 5b, and placed on the hatch-cover receiving platform 10 supported by the platform bearing structure Z. This greatly shortens the cycle time as against lifting and placing the hatch covers at ground level.

FIG. 7 illustrates the same embodiments of the crane apparatus of the invention as shown in FIGS. 1 through 6, the only difference being that, instead of a pier 14 constructed on, for example, the slab, plinth and piling principle, the foundation in this case is one or more caissons 19. The heavy loads, both static and dynamic, created by, for example, five mobile parent quayside container cranes 1 operating at maximum cycle speed while unloading/loading a large container ship A, under certain conditions, may be better compensated for by a crane platform comprised of large, demountable, ballastable, trimmable, concrete caissons 19. Such caisson platforms 19, and their use, are described in detail in U.S. Pat. No. 6,017,617 by the same inventor, which is incorporated herein by reference.

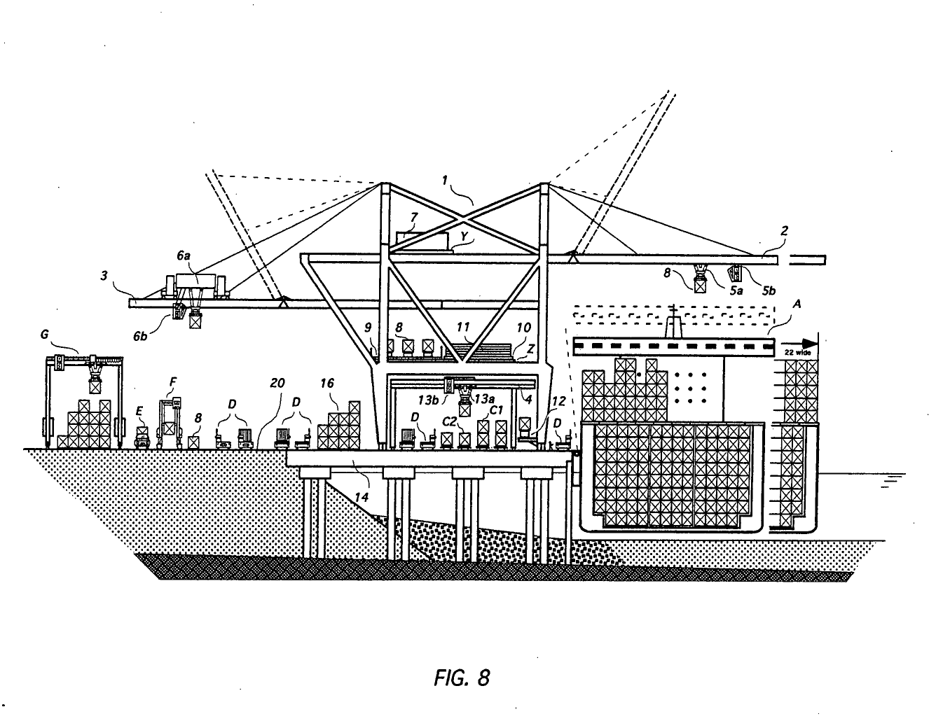

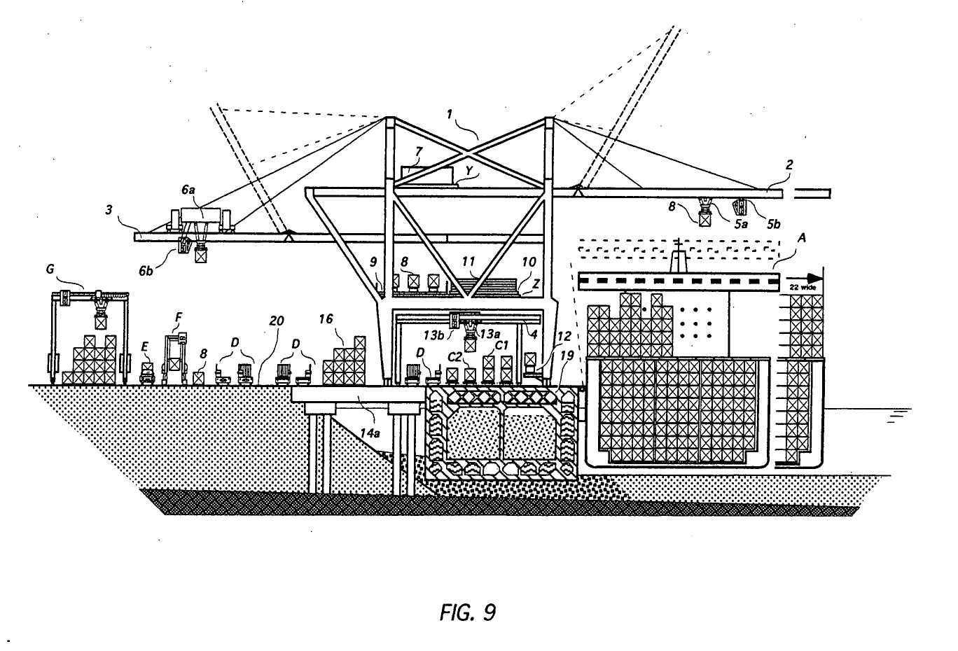

FIGS. 8, 9 and 10 show embodiments of the crane apparatus of the invention installed on wharves or bulkhead wharves 20. FIG. 8 shows a typical wharf or bulkhead wharf 20 built by standard construction. In this case, for example, the dock front is shown as being constructed by the plinth, slab and piling method. FIG. 9 shows, for example, the wharf or bulkhead wharf 20 constructed using caissons 19 together with a concrete apron 14a.

One difference between the embodiments of the invention shown in FIGS. 8, 9 and 10, as against that shown in FIG. 1, is that the fixed platform for storing restow containers is not required. With the added land available back from the dock face and cranes, the option exists as to whether to restow containers 16 on a fixed platform or on the ground.

Also with added backland being available with a wharf or bulkhead wharf installation 20, and as shown in FIGS. 8, 9 and 10, it is possible that a wider range of container moving-and-handling equipment can be utilized. The more restricted real estate available with piers 14 results in the over-the-ground equipment that can be used being limited as to type and numbers. In the case of wharves and bulkhead wharves 20, as can be seen in FIGS. 8, 9 and 10, other types of equipment can be used, especially those that require more room to maneuver, such as multi-trailer sets (MTS) E, rubber-tired gantries (RTGs) G, and straddle carriers F. Also readily usable in this category, but not shown, would be reach-stackers and top-picks.

All the direct transshipment functions that the parent quayside container cranes 1 and their sibling RMG cranes 4 are described as being able to execute in the embodiments of FIGS. 1-7 on piers 14, are capable of being executed on the wharves and bulkhead wharves 20 in the embodiments of FIGS. 8-10. The Poseidon™ crane system will be just as cost-effective and as efficient in terms of lifts per hour, and cycle time, whether installed on a pier, a wharf or a bulkhead wharf.

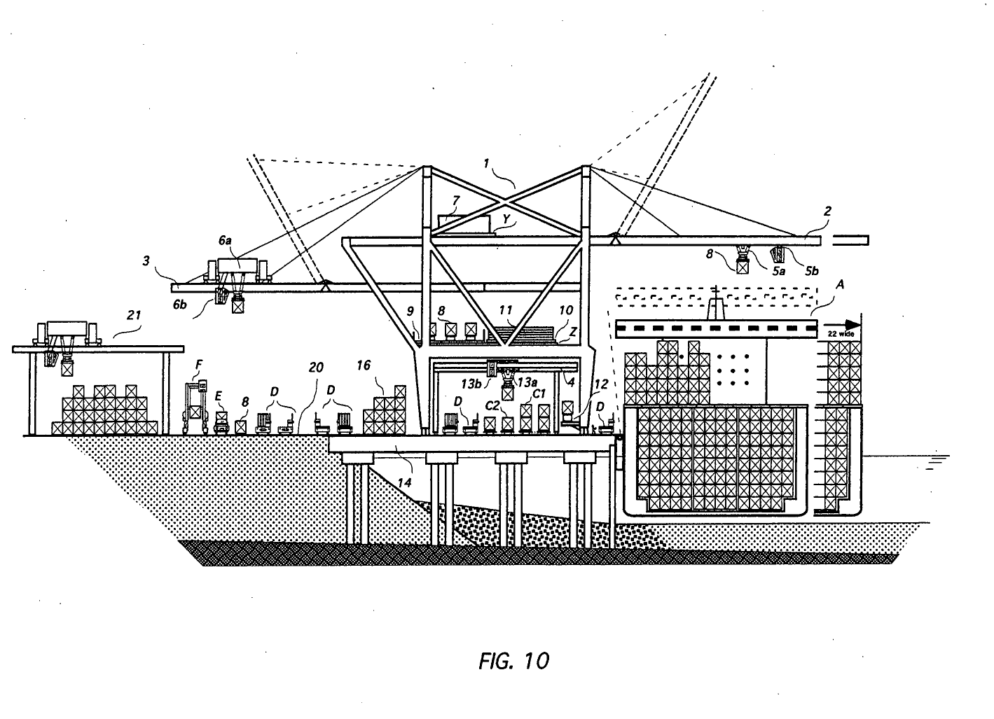

FIG. 10 differs from FIG. 8 only in that it shows the installation of automated overhead bridge cranes (OBCs) 21 for stacking containers in the terminal. The installation of the OBCs 21 reduces the handling cost per container and allows for a greatly increased stacking density per acre. Recent developments in this area in Singapore, Hong Kong and Antwerp, where backland is relatively restricted, have seen the installation of OBC systems resulting in a terminal efficiency in the order of 11,000 TEUs/acre/year. For comparison purposes, the efficiency of the Port of NY/NJ container terminals is in the order of 1,250 TEUs/acre/year.

Ideally, as shown in FIG. 10, the machine trolley-hoist-spreader 6a, under the control of an operator in the operator control cabin 6b, would drop the container 8 to the ground as close to the backlegs of the cranes as possible. From there, 1-over-1 shuttle straddle carriers (such as those of Kalmar Industries) would only have to move the containers 8 a short distance to a point where the OBCs 21 can pick them up and transfer them into the stacks. The combined efficiencies of the Poseidon™ crane system, together with automated overhead bridge cranes in a stacking area as close as possible to these cranes, would result in the most efficient and cost-effective marine container terminal layout and design, especially in areas where backland is restricted.

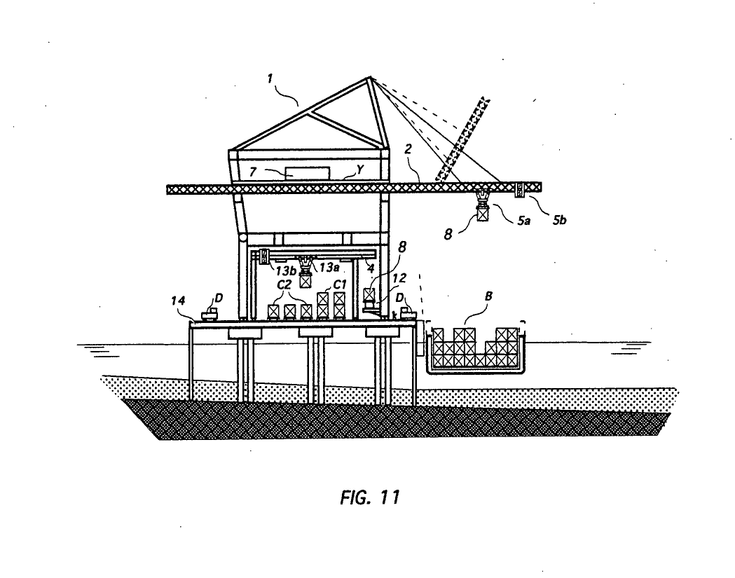

FIG. 11 shows an embodiment of the crane apparatus of the invention which is smaller, and lower in height, than the embodiments described heretofore. This embodiment of crane apparatus also has parent quayside container cranes 1 and sibling RMG cranes 4 and is designed to transship containers directly between container barges B and double stack C1, and/or single stack C2, container rail-cars that are part of cuts of container unit-trains positioned immediately under the cranes. As it does not have to transship containers 8 from large containers vessels A, as shown in FIGS. 1-3 and 5-10, this combination of cranes can be of a far more compact design and therefore cost considerably less to construct.

This embodiment of the invention can also be installed on piers 14, as shown in FIG. 11, or on a wharf or bulkhead wharf, similar to those shown in FIGS. 8, 9 and 10.

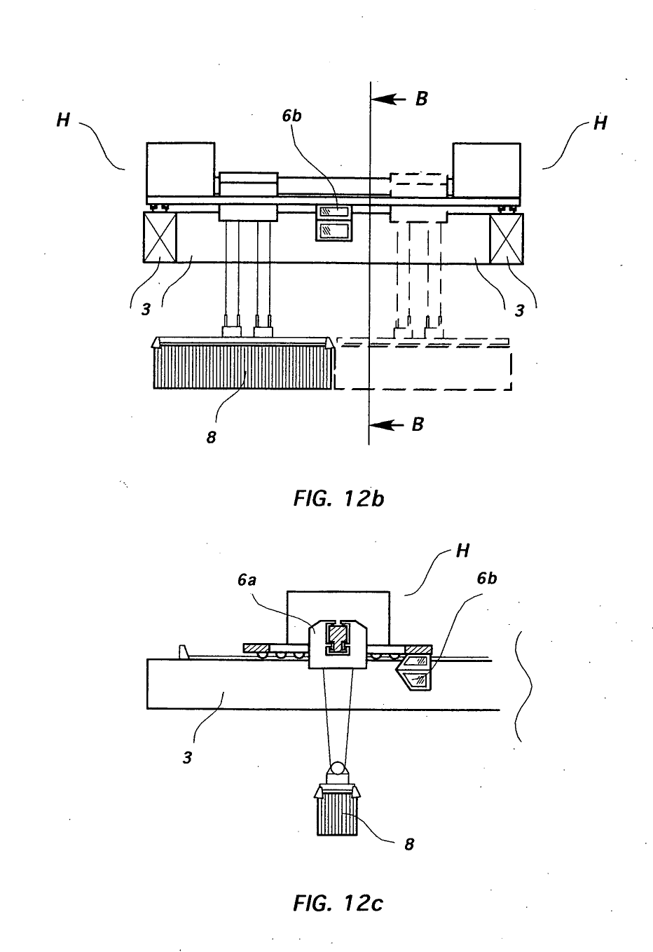

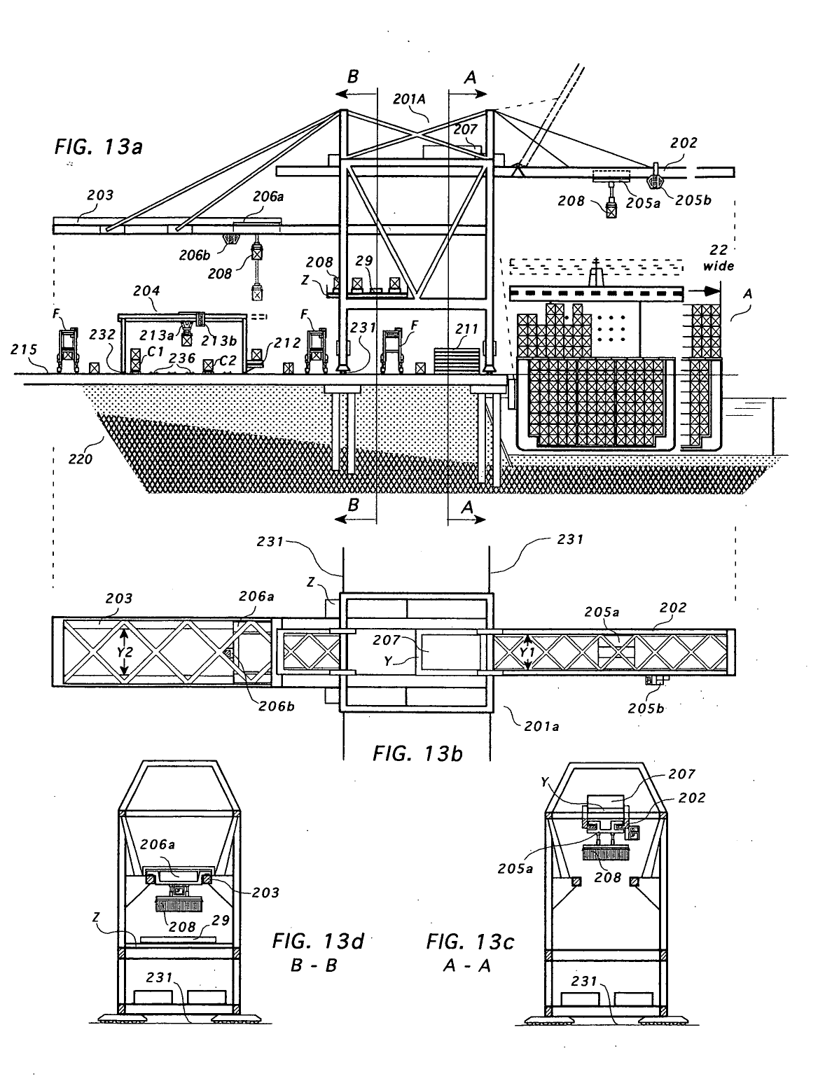

Another exemplary embodiment of a crane apparatus and method according to the invention using double boom (DB) cranes for the direct transshipment of marine containers between vessel and rail modes, without the necessity of ground placement, is shown in FIGS. 13 and 14 and, more specifically, in FIGS. 13a, 13b, 13c, 13d.

As shown in FIG. 13a, the crane apparatus comprises a double boom (DB) crane 201A mounted to travel along a set of rails 231 provided on a wharf apron 215 of a wharf 220. A sibling crane 204 is mounted to travel along a set of rails 232 on the wharf apron 215, and the set of rails 232 are positioned underneath a backreach boom 203 of the DB crane 201A so that the sibling crane 204 can travel back and forth along the rails 232 underneath the backreach boom 203. The DB crane 201A and its sibling crane 204 are powered by electric motors in a manner well known in the art, and the two cranes are separately controlled, independently of each other, to travel in either direction along their own sets of rails.

FIG. 13a shows the DB crane 201A transferring containers 208 from a vessel A to a container receiving platform 212 of the sibling crane 204. The sibling crane 204, having its own trolley-hoist-spreader 213a, under the control of an operator in a control cabin 213b, and being able to move independently on its own set of rails 232, then can load containers 208 directly onto double-stack rail cars C1 or single-stack rail cars C2.

FIG. 13a shows, by way of example, six parallel sets of container unit-train rail tracks 236 underneath the sibling crane 204. As is shown in the terminal plan in FIG. 14, each of these sets of rail tracks runs along the wharf apron 215 parallel to the wharf front and each set of rails tracks can thus accommodate a cut of container unit-train rail cars C1-C2.

This intermodal ship-to-rail container transfer, without the necessity of ground placement, and as shown in FIGS. 13a, 13b and 13c, is undertaken in a number of steps:

First: A trolley-hoist-spreader 205a on an outreach boom 202 of the DB crane 201A, under the control of an operator in a control cabin 205b, lifts a container 208 from the vessel A and places it on one of the three or more buffer-slot platforms (fixed container-receiving platforms) 29 located on a deck (bearing platform) Z of the crane 201A.

Second: A trolley-hoist-spreader 206a on the backreach boom 203 of the DB crane 201A, under the control of an operator in a control cabin 206b, lifts the container 208 from the buffer-slot platform 29 on the deck Z and deposits it directly on a platform 212 of the sibling crane 204, which has been positioned along the set of rails 232 so that the platform 212 of the sibling crane is aligned directly underneath, and in the same vertical plane, as the trolley-hoist-spreader 206a.

Third: The operator in the control cabin 213b of the sibling crane 204 operates the trolley-hoist-spreader 213a of the sibling crane 204 to lift the container 208 from the platform 212 and load the container directly onto a container double-stack rail car C1 and/or a single-stack rail car C2.

The trolley-hoist-spreader 205a on the outreach boom 202 of the DB crane 201A is usually powered by electric winch and cable, with the winch typically being located in a machinery house 207 located on a platform Y above the outreach boom 202. Similarly, the trolley-hoist-spreader 213a on the sibling crane 204 is usually of an electric winch-and-cable design. The trolley-hoist-spreader 206a on the backreach boom 203 of the DB crane 201A is of a size and weight that requires it to be most usually of the self-propelled type of machinery trolley.

FIG. 13b is a plan view of the DB crane 201A from above the crane. This plan view shows the difference in width between the girders of the outreach boom 202 and backreach boom 203 of the DB crane 201A. As is shown in FIG. 13b, the distance Y2 between the girders of the backreach boom 203 is considerably wider than the distance Y1 between the girders of the outreach boom 202. This is required so that the trolley-hoist-spreader 205a (and the container 208 it is carrying) can pass between the girders of the backreach boom 203 thus enabling the trolley-hoist-spreader 205a to place its container 208 directly on a buffer slot platform 29.

FIG. 13b also shows the relative size difference between the winch-and-cable trolley 205a on the outreach boom 202 and the machinery trolley 206a on the backreach boom 203 of the crane 201A.

FIGS. 13c and 13d are cross-sectional elevational views of the crane 201A. A comparison of these two cross-sectional elevations also explains more clearly the necessary difference in boom width between the outreach boom 202 and the backreach boom 203.

FIG. 14 is a plan view of a marine container terminal showing an Ultra Large Container Vessel (ULCV) A, of 12,000 TEU capacity, being unloaded at a wharf with eight ship-to-shore container DB gantry cranes 201A. This number of cranes is necessary in order to unload/load such a large vessel in the required time. The DB cranes 201A are mounted on their own sets of rails 231 and have outreach booms 202 and backreach booms 203. The DB cranes 201A are shown transferring containers, without the necessity of ground placement, from the vessel A to cuts of unit-train rail cars C1-C2 which are arrayed along the wharf apron 215 of the wharf 220 under the backreach booms 203.

FIG. 14 also shows the disposition of the independently rail-mounted sibling cranes 204, on their own sets of rails 232, which are associated with parent DB cranes 201A. A cutaway in FIG. 14 shows a plan view of two sibling cranes 204 with their container receiving platforms 212.

As a result of being able to directly transfer containers 208 from the vessel A to cuts of unit-train rail cars C1-C2 without the need for ground placement, three important efficiencies in the logistics chain are achieved:

First: The traffic congestion and pollution problems are greatly reduced at such terminals. FIG. 14 shows a logistics system whereby containers are loaded from a vessel directly onto unit-trains thus reducing the need for large container stack areas J and the large number of straddle carriers F and stack RMGs K1 (and other in-yard terminal equipment) otherwise having to be employed.

Second: The number of containers leaving the terminal on road trailer-trucks L, and exiting the terminal portals M1-M2, is likewise significantly reduced.

Third: Overall terminal labor costs and terminal capital equipment costs are significantly reduced.

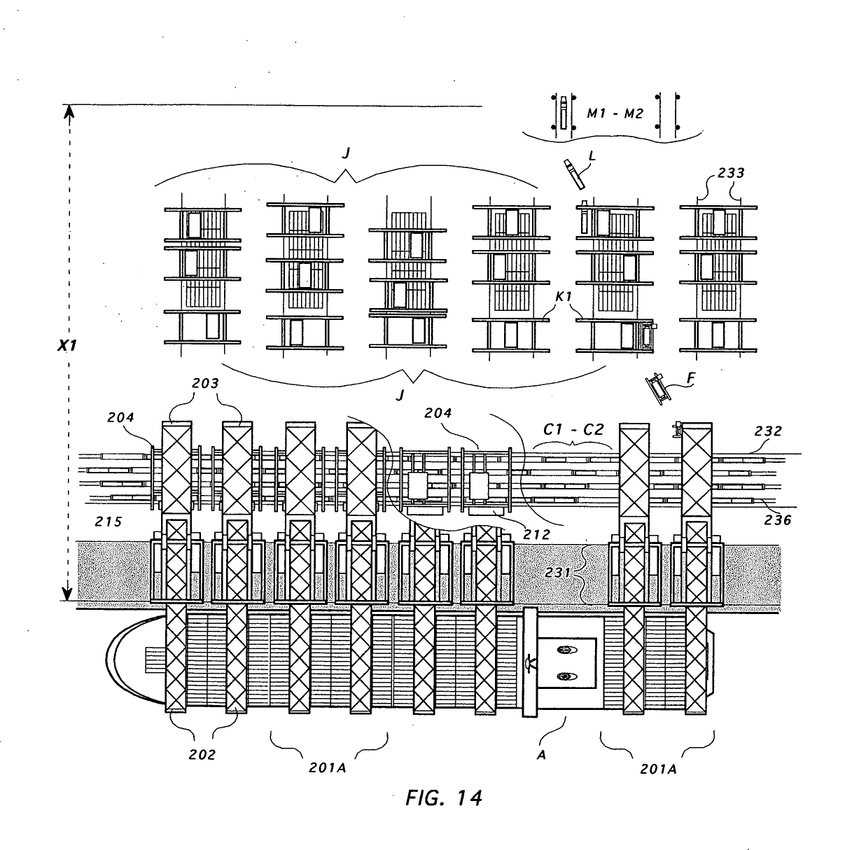

FIG. 15 is a plan view of a typical ship-to-truck and ship-to-near-dock rail terminal as is currently operated. FIG. 15 shows, by way of example, a ULCV being unloaded at a wharf by eight standard single boom SB cranes 205.

The container logistics pattern in predominantly ship-to-truck type terminals usually follows six steps (not including movement of containers within the stacks):
Step 1: Containers are transferred from the vessel A and deposited on a wharf apron 215 of a wharf 220 directly under the SB cranes 205.
Step 2: Straddle carriers F (or other in-yard terminal equipment) take the containers from these locations and move them to the stack areas J.
Step 3: At the stack areas, RMGs K1, on their own sets of rails 233, (or other in-yard terminal equipment) stack the containers in the container stacks in stack areas J.
Step 4: The RMGs K1, (or other in-yard terminal equipment) place the containers from the stacks onto the terminal pavement.
Step 5: Straddle carriers F (or other in-yard terminal equipment) again take the containers and move them to the unit-train load-out facility and place them on the terminal pavement within reach of RMGs K2, on their own sets of rails 234.

In an alternative container logistics pattern:
Step 5: The RMGs K1 load the containers onto road trailer-trucks L that then exit the terminal through the exit portals M1-M2.
Step 6: The RMGs K2 pick up the containers and load them onto the container unit-train cuts C1-C2.

The advantages of DB crane versus SB crane terminal layouts can be seen by comparing FIGS. 14 and 15. These advantages are:

1. The smaller footprint of the DB crane terminal. The area required for a similar TEU thruput capacity terminal is significantly less.

2. As a result, the total aggregate distance of all diesel-powered container movements within the terminal, with their congestion and pollution impacts, is also significantly reduced.

3. The area saving translates into a more compact terminal. For example, the shorter distance of the transverse axis X1 of the DB crane terminal in FIG. 14 is only 60% the distance of that of the comparable axis X2 shown in FIG. 15 in the SB crane terminal. This represents a 40% saving in the most critical dimension of terminals, especially those located in densely populated port cities.

4. The numbers of the in-yard terminal equipment required are reduced (straddle carriers, RTGs, RMGs, yard-tractors, top-picks, etc.).

5. The capital costs and labor requirements of this equipment are significantly less.

6. The turnaround time for the container vessels is reduced.

7. The overall capital and operating costs of the terminal are less even though the capital and operating costs of the DB cranes 201A are greater than that of the SB cranes 205.

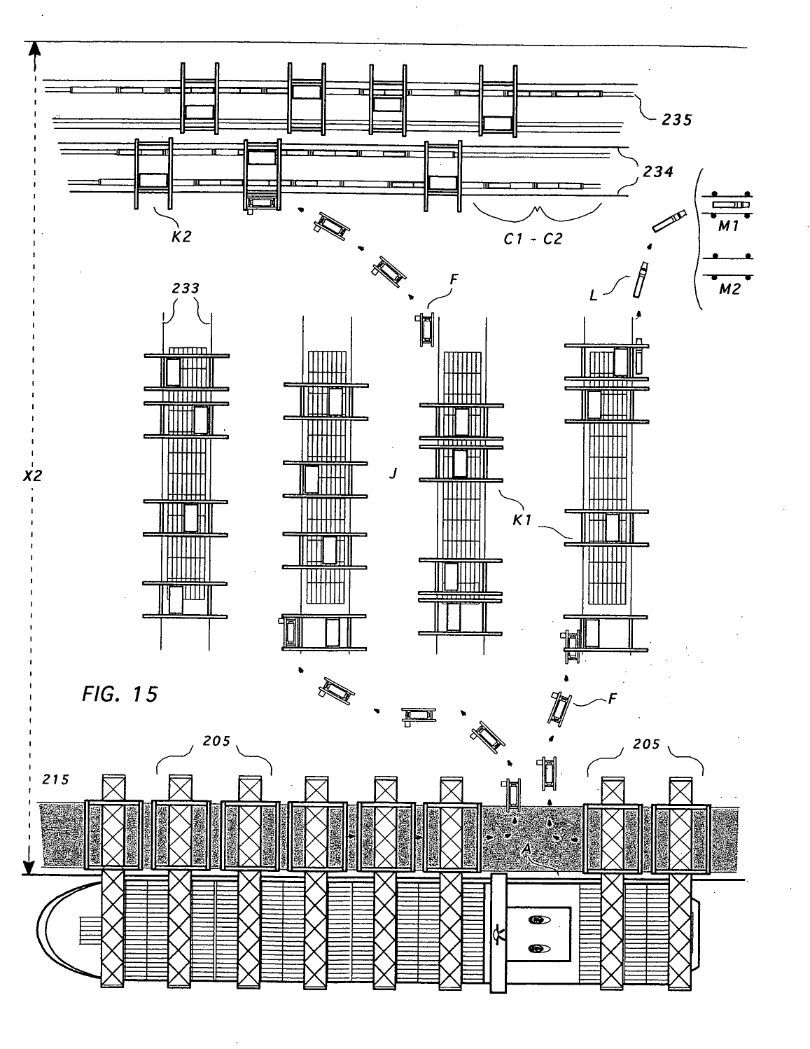

FIGS. 16a, 16b, 16c and 16d show another exemplary embodiment of crane apparatus and method according to the invention for the direct transshipment of containers 208 between a vessel A and another vessel or vessels B without the need for ground placement of the containers. DB cranes 201B are mounted on rails 231 installed on a pier 214. On one side of the pier 214 is moored a ULCV A, and on the other side are moored one or more container feeder vessels (or container barges) B.

In FIG. 16, the configuration of the outreach boom 202 on the DB crane 201B is the same as that of the DB crane 201A shown in FIG. 13. However, as shown in FIGS. 16b and 16d, the backreach boom 206 of the DB crane 201B is entirely different in this embodiment of the invention. The boom itself is wider and the trolley-hoist-spreader 207a on the boom is of different design from that in the FIG. 13 embodiment. The trolley-hoist-spreader 207a is designed to be, in effect, a double trolley. Specifically, one trolley within the other. A motor-driven main trolley 207a moves backwards and forwards along the backreach boom 206. Mounted on rails, at right angles to this line of motion, and within the main trolley 207a, is a second trolley 207c, also motor driven. The second, internal, trolley 207c contains the winch and cable system of the hoist-spreader of the trolley-hoist-spreader 207a.

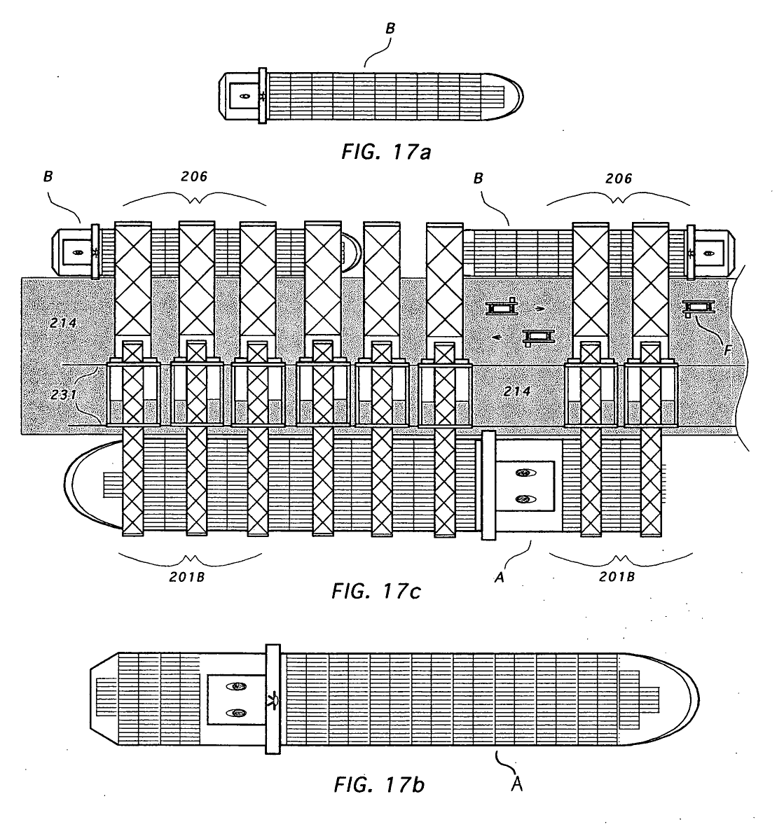

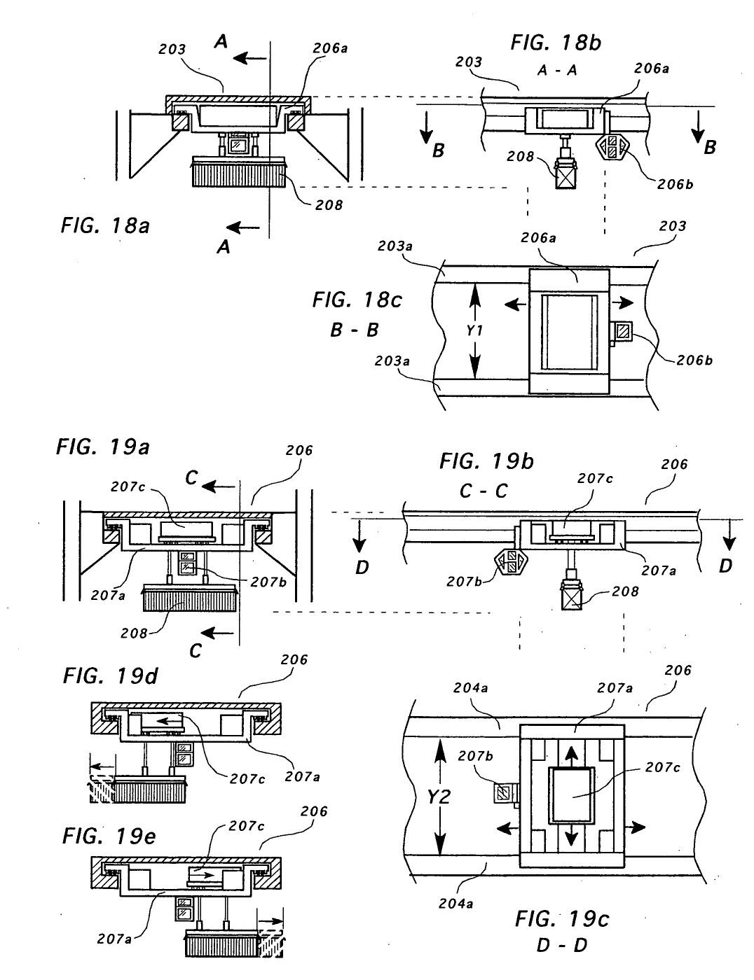

With this configuration, the DB crane 201B, while remaining at a fixed location over one cell of the vessel A can, in effect, load two adjacent cells of the much smaller feeder vessel B, without the need for movement of the vessel B. In practice, the number of containers being unloaded for a single ULCV cell can reach as high as 100+, whereas the cell capacity of even a large feeder vessel may be no more than 50. By using the double-directional trolleys 207a and 207c, neither the DB crane 201B nor the vessels A and B have to move while the crane is unloading the ULCV's cell. The double-directional trolleys 207a and 207c can load two adjacent 50 capacity feeder vessel cells while the DB crane 201B remains fixed in location while unloading a single ULCV 100 capacity cell. A more detailed comparison of the various trolleys described heretofore can be gained from FIGS. 18a, 18b, 18c, and 19a, 19b, 19c, 19d, 19e.

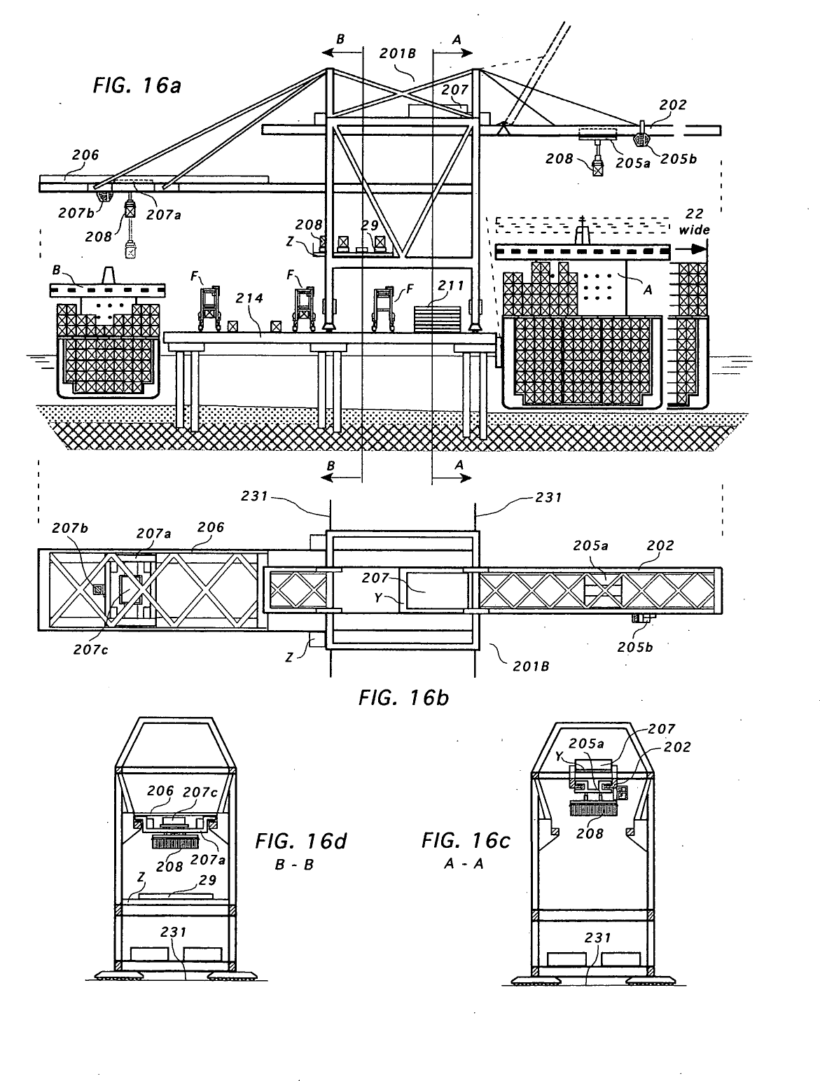

FIG. 17c shows a plan view of a terminal where DB cranes 201B, on rails 231, with backreach booms 206 (and double-directional trolleys 207a and 207c), are shown directly transshipping containers between a vessel A, on one side of a pier 214, to container feeder vessels (or container barges) B on the other side of the pier 214, without the need for ground placement of the containers.

FIGS. 17a and 17b demonstrate the large size difference between present day ULCVs A and large feeder vessels (or container barges) B.

A practical example of the need for such a direct vessel-to-vessel transshipment system, without the delay caused by ground placement, and subsequent multiple handling, can be seen in the Port of Norfolk, Va. At the present time, 30% of the containers on ships entering the Port of Norfolk are offloaded and moved through terminal stacks for eventual load-out onto road trailer-trucks destined for the Baltimore area. The ability to directly transfer containers from deep-sea vessel to feeder vessel, or to container tug-barge systems sailing up the Chesapeake Bay to Baltimore, would significantly reduce the pollution, and time and costs, involved with this excessive dependency on trucking.

FIGS. 18 and 19 show details of types of trolleys described heretofore. FIGS. 18a and 18b are cross-sectional views, and FIG. 18c is a plan view, of the trolley-hoist-spreader 206a on the backreach boom 203 of the DB cranes 201A. FIGS. 19a and 19b are cross-sectional views, and 19c is a plan view, of the double trolley 207a/207c under the control of an operator in the control cabin 207b used on the backreach boom 206 of the DB cranes 201B. FIG. 19c is a plan view of the main trolley 207a and the internal trolley 207c. In FIG. 19c, arrows show the bi-directional movements of both trolleys, i.e., the movements of the main trolley 207a, back and forth, along the backreach boom 206, and the transverse, across boom movements, of the internal trolley and its hoist-spreader 207c. FIGS. 19d and 19e show in greater detail how, when the main trolley 207a is stationary, the internal trolley 207c can move laterally and load containers into two adjacent cells of a feeder vessel. As also shown in FIGS. 19d and 19e, part of this dual cell loading capability is also a function of utilizing standard spreader extension arms which can move a container a further distance laterally of up to 5 feet without the trolley-hoist-spreader 207c having to change position.

In both DB crane 201A and 201B configurations, the deck for the buffer-slot platforms 29 at the gantry portal level of the cranes is the same. FIGS. 13a and 16a both show the deck (bearing platform) Z installed at sufficient height above the wharf apron 215, and in such a location as to allow for the free movement of in-terminal container transfer vehicles, such as straddle carriers F (yard-tractors, top-picks, etc.) to move freely under the cranes 201A and 201B. In both DB crane 201A and DB crane 201B configurations, the trolley-hoist-spreader 205a on the outreach boom 202 is the same. Both crane designs allow the trolley-hoist-spreader 205a to lift hatch covers 211 from the vessel A and deposit them on the wharf apron 215 directly under and between the crane rails of the DB cranes 201A and 201B.

Up to this point, only the buffer-slot platform portion 29 configuration on the deck (bearing platform) Z of the DB cranes 201A and DB cranes 201B has been considered. It has now become possible due to advances in several types of detector technology to consider an additional configuration of platforms on the decks Z on the cranes DB 201A and DB 201B, namely, a configuration that enables the security scanning and screening of containers while in position on such platforms. In this configuration, the deck Z on the cranes 201A and 201B has to be heavier in construction than the aforesaid decks Z in order to accommodate scanning platforms and equipment that allow for the scanning and screening of any container placed upon them.

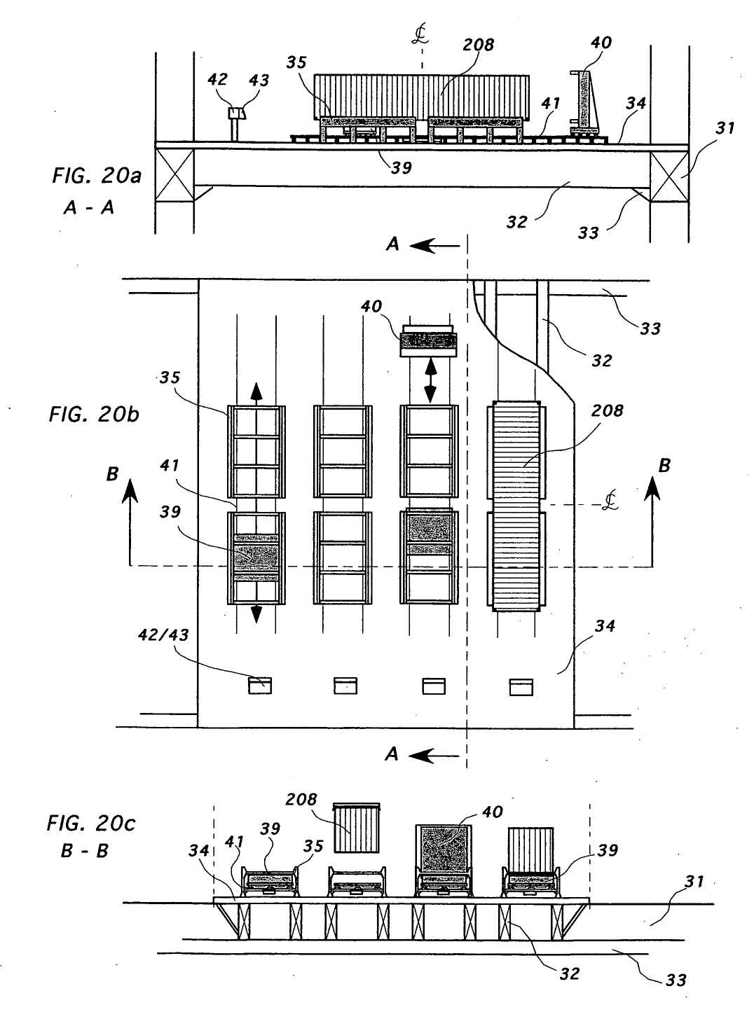

FIGS. 20a, 20b and 20c show, respectively, side elevational, plan and cross-sectional elevational views of such a deck and scanning platform system placed upon them as shown in my U.S. Pat. No. 6,845,873 which is incorporated herein by reference in its entirety. One or more detectors 39, which may be gamma ray, neutron, X-ray, spectroscopic or other type detectors, or a combination thereof, are installed on a motorized trolley that rides on rails 41 under scanning platforms 35 on which a container 208 is placed during loading or unloading. The platforms 35 are mounted on a deck 34 that is similar, but heavier in construction, to the aforedescribed decks Z. As shown, the platforms 35 are disposed in pairs, in end-to-end relationship, to accommodate thereon a 40′ (or a 45′) container 208. System-of-systems electronic data acquisition, read-out and display console/monitors 42/43 are also mounted on the deck 34. The deck 34 is mounted on beams 32 that are affixed to the crane framework and supported by support brackets 33 welded to the framework.

In this configuration, it is possible to reliably scan containers to determine whether a “dirty bomb” or its shielding have been inserted into a container. While important in its own right, detection of “dirty-bombs” and their shielding is no longer the only detection technology available that can be utilized on the decks 34. The breakthrough has come in the development of small installations of Integrated Container Security Scanning Systems (ICSSS) that can detect chemical and biological as well as radiological emissions; and, as importantly, analyze these emissions within a much shorter time scale than previously. The addition of chemical and biological capability, to the already well-understood radiological detection capability, makes for an efficient, cost-effective, and reliable method for the integrated security scanning of every container leaving or entering a ship.

Unlike radiological detectors, the additional chemical and biological detection capability is better installed in vertical rather than horizontal detectors. FIGS. 20a, 20b and 20c show CBEN detectors 40 mounted on rails on motorized trolleys. The CBEN detectors 40 are designed so that they can be moved to envelop the end of the container during the scanning and screening process. In actual practice, the CBEN detectors 40 are preferably provided at each end of each pair of scanning platforms 35, and the trolley-mounted detectors 39 are provided beneath each pair of scanning platforms 35.

With scanning and interpretation times now down to 30 seconds and less per container, such an Integrated Container Security Scanning System can operate in parallel, within the same time cycle and in synchronization, with the outreach trolley-hoist-spreader 205a, and backreach trolley-hoist-spreaders 206a and 207a on the DB cranes 201A and 201B.

In summary, when fully automated, with automated stops on the booms, and with the operator cabs separated from their trolleys (in order to lessen repetitive G-force stresses on their operators), the DB cranes 201A and DB cranes 201B should be able to maintain 60 lifts per hour without intermediate scanning, and 45 lifts per hour including intermediate scanning (with all containers being scanned and screened by Integrated Container Security Scanning Systems).

The DB cranes 201A and DB cranes 201B can be installed on wharfs and piers constructed by traditional methods, such as slab, plinth and pile, as shown in FIGS. 13a and 16a. The DB cranes 201A and 201B can also be installed on wharf, bulkhead wharf or pier caissons such as those described in my U.S. Pat. Nos. 5,803,659; 6,017,167; 6,234,714 and 6,845,873 which are incorporated herein by reference in their entireties.

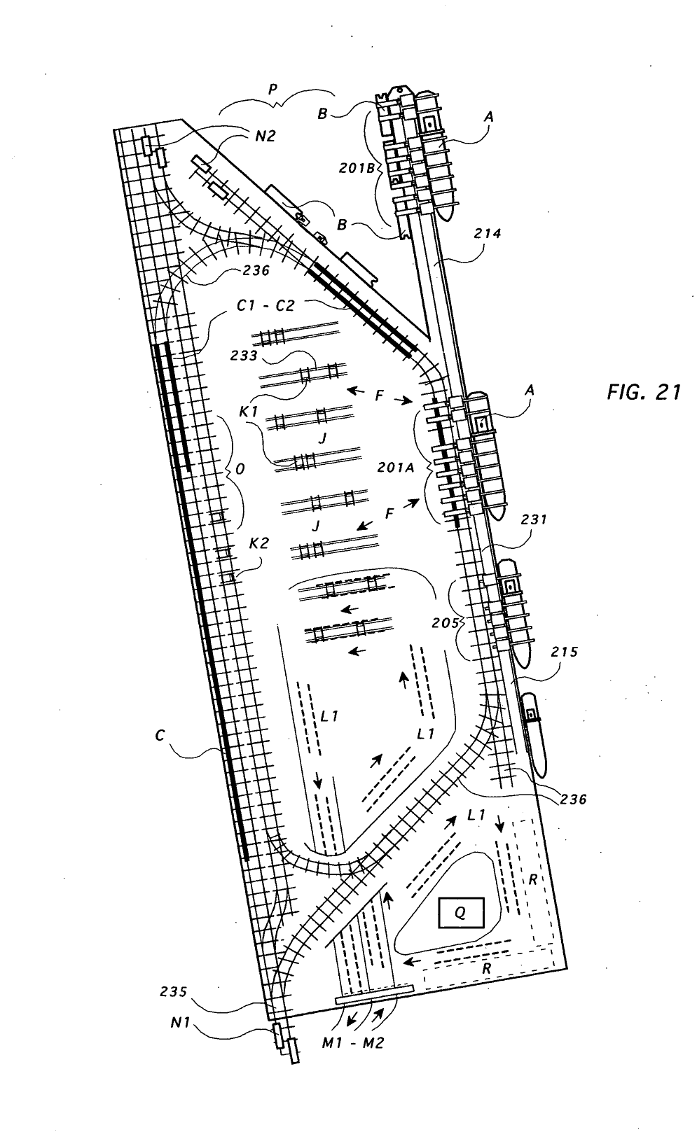

FIG. 21 shows an illustrative layout of an optimal intermodal terminal fully utilizing the direct transshipment ship-to-rail double boom cranes 201A and the direct transshipment ship-to-feeder vessel (or container barge) double boom cranes 201B. FIG. 21 shows the crane rails 231 running along the wharf apron 215 upon which the double boom cranes 201A and 201B travel. Single boom cranes 205 may also be used for loading and unloading smaller vessels.

The double boom cranes 201B are positioned on a pier 214, transshipping containers directly between a vessel A and container feeder vessels (or alternatively container barges) B. After unloading and loading all containers to be transshipped between vessel and feeder vessels/barges, the vessel A is moved to a position under the double boom cranes 201A.

FIG. 21 shows a container unit-train C brought to, and leaving from, the terminal by main line locomotives N1. The unit-train C has double-stack C1 and single stack C2 rail cars. The main line locomotives N1 bring into, and take out from, the terminal container unit-trains C over main line rails 235.

In-yard shunt engines N2 move cuts of unit-train rails cars C1-C2 over in-yard rail lines 236 for positioning under the direct transshipment ship-to-rail cranes 201A. In the same manner as shown in FIGS. 13 and 14, the cranes 201A transship containers between vessels A and their sibling cranes 204, via the buffer-slot platforms 29 or the buffer-slot and scanning platforms 35, so as to complete the container loading/unloading cycle between vessel and cuts of unit-trains C1-C2. Containers not to be loaded on cuts of unit-train rail cars C1-C2 are placed on the terminal apron 215 at the furthest outreach of the backreach booms 203 of the double boom cranes 201A.

At this ground location, the containers are shown as being picked up by shuttle-carriers F and moved under the outside arms of the rail-mounted gantries (RMGs) K1. The RMGs K1 are mounted on their own sets of rails 233 in the terminal container stack area J. The RMGs K1 pick-up the containers and place them into the container stacks in the container stack area J.

When ordered to leave these stacks, the RMGs K1 lift the containers from the stacks and place them outside the stacks on the terminal pavement for subsequent pick-up by straddle carriers F, or alternatively, the RMGs K1 can load the containers directly out of the stacks onto road trailer-trucks parked under their outside arms. In FIG. 21, lanes of road trailer-trucks L1 are shown waiting for, and parked under, the RMGs K1. FIG. 21 shows with arrows the route of inbound and outbound road trailer-trucks L and their arrival and departure through terminal exit portals M1-M2.

FIG. 21 shows the main areas in the terminal to be:

| | |
|---|---|
| Pier | 214 |
| Wharf and apron | 215 |
| Unit-train waiting area | O |
| Barge harbor | P |
| Terminal stack area | J |
| Road trailer-truck lanes | L1 |
| and waiting areas | |
| Truck portals | M1-M2 |
| Administration building | Q |
| Employee parking | R |

In this detailed description of the terminal the emphasis, for clarity purposes, has been on the handling of import containers, i.e., the transshipment from vessel to rail, from vessel to barge and from vessel to road trailer-truck. It should be noted that the terminal is equally designed to facilitate the efficient handling of export containers, i.e., the transshipment from rail unit-train to vessel, from barge to vessel and from road trailer-truck to vessel.

The container logistics system shown in detail in FIG. 21 gives the Port of Norfolk, for example, the opportunity to build the most modern, most efficient and least polluting marine terminal in the United States, if not in the world.

The backreach booms 203 of the cranes 201A are designed, in terms of their length and width, to enable the cranes to undertake four specific functions:
1. In terms of boom 203 length, to enable the cranes 201A to transship containers 208 between a vessel A and container rail-cars C1 and C2 by utilizing their associated sibling cranes 204; and to do this directly, without the need for ground placement of the containers.
2. In terms of boom 203 length, to enable the cranes 201A to transship containers 208 between a vessel A and that area of the wharf apron 215 directly under the farthest end of the backreach booms 203, such containers being destined specifically for transfer by shuttle-carriers F (or other in-yard terminal equipment) to and from this location and the container stacks J.
3. In terms of boom 203 length, to enable the cranes 201A to transship containers 208 between a vessel A and that area of the wharf apron 215 between the cranes 201A and their associated sibling cranes 204, the containers at this location being temporarily stored before restow back aboard the vessel A.
4. In terms of boom 203 width, to transship containers between a vessel A and buffer-slot platforms 29 or buffer-slot and scanning platforms 35 located on decks Z at the gantry portal level of the cranes 201A. This width, of necessity, being wide enough to enable the passage of the containers, and the spreaders of the trolley-hoist-spreaders 205a carrying them, between the girders of the boom 203.

In practice, the areas needed by these functions directly under the booms 203 on the cranes 201A require the booms 203 to have a minimum length of approximately no less 185′, i.e, 185′+ from the inboard crane rail of the cranes 201A to the farthest end of the booms 203. This minimum length of the booms 203 is predicated on there being four parallel unit-train rail tracks serviced by the sibling cranes 204. Preferably, if the terminal's modal transfer is primarily to be one of ship-to-rail rather than ship-to-truck, there should be six such parallel tracks. In this case, the booms 203 preferably have a length of approximately 210′±. With ULCV's now at 22 containers across, the outreach booms 202 of the cranes 201A would have to be 200′± in length (from outboard crane rail to the farthest end of the booms 202). With the backreach booms 203 running approximately between 185′± and 210′±, the cranes are “in balance” from a center of gravity standpoint, and far more so than can be said for any single boom cranes.

In practice, the necessary width between the boom 203 girders has to be greater than the longest dimension of the spreader of the trolley-hoist-spreader (205a) and the container that it is carrying. Many marine containers are now 45′ long, as against their more traditional length of 40′. This 45′ container length, plus the overhangs of the spreader, plus the safety margin to eliminate collision from the spreader and container swaying, require that the minimum width between the boom 203 girders be on the order of 54′±.

In summary, it is the four functions required to be performed by the backreach booms 203 of the cranes 201A that primarily dictate the length and width necessary for the booms 203. While illustrative dimensions have been described, the invention is not limited or restricted to these dimensions, which have been provided only for illustrative purposes.

While the present invention has been described with reference to presently preferred embodiments thereof, other embodiments as well as obvious variations and modifications to all the embodiments will be readily apparent to those of ordinary skill in the art. The present invention is intended to cover all such embodiments, variations and modifications that fall within the spirit and scope of the appended claims.

What is claimed is:

1. A crane apparatus installed on a foundation that extends into water for directly transshipping containers from a vessel moored alongside the foundation to another transportation mode without ground placement of the containers, the crane apparatus comprising: a parent crane that is movable along a trackway extending lengthwise along the foundation and that unloads containers from a vessel moored alongside the foundation and places them on a first platform affixed to the parent crane; and a sibling crane that is movable along the foundation at ground level, independently of movement of the parent crane along its trackway, and that loads containers from the first platform directly onto over-the-ground vehicles without ground placement of the containers.

2. A crane apparatus according to claim 1; wherein the parent crane has a first trolley-hoist-spreader movable along an outreach boom for unloading containers from the vessel and placing the containers on either the first platform or a second platform of the parent crane, and a second trolley-hoist-spreader movable along a backreach boom for loading containers from the second platform onto another vessel moored alongside the foundation or onto over-the-ground vehicles without ground placement of the containers.

3. A crane apparatus according to claim 2; wherein the second trolley-hoist-spreader is movable in both lengthwise and widthwise directions of the backreach boom.

4. A crane apparatus according to claim 2; wherein the second trolley-hoist-spreader is movable in both lengthwise and widthwise directions of the backreach boom to enable loading of containers from the second platform onto another vessel in plural cells while the parent crane remains in a fixed position along the foundation.

5. A crane apparatus according to claim 2; wherein the second trolley-hoist-spreader is movable in both lengthwise and widthwise directions of the backreach boom to enable loading of containers from the second platform onto a plurality of over-the-ground vehicles positioned in end-to-end relation in the lengthwise direction of the foundation while the parent crane remains in a fixed position along the foundation.

6. A crane apparatus according to claim 2; wherein the sibling crane is movable along a trackway that runs beneath the backreach boom of the parent crane.

7. A crane apparatus according to claim 1; wherein the sibling crane is movable along a trackway that runs beneath the parent crane.

8. A crane apparatus installed on a foundation that extends into water for directly transshipping containers from a vessel moored alongside the foundation to another transportation mode without ground placement of the containers, the crane apparatus comprising: a double boom crane movable along a trackway that extends along the foundation, the double boom crane having a first trolley-hoist-spreader moveable along an outreach boom for unloading containers from a vessel moored alongside the foundation and placing them on a platform of the crane, and a second trolley-hoist-spreader movable along a backreach boom for loading containers from the platform onto another vessel moored alongside the foundation or onto over-the-ground vehicles without ground placement of the containers.

9. A crane apparatus according to claim 8; wherein the second trolley-hoist-spreader is movable in both lengthwise and widthwise directions of the backreach boom.

10. A crane apparatus according to claim 8; wherein the second trolley-hoist-spreader is movable in both lengthwise and widthwise directions of the backreach boom to enable loading of containers from the second platform onto another vessel in plural cells while the parent crane remains in a fixed position along the foundation.

11. A crane apparatus according to claim 8; wherein the second trolley-hoist-spreader is movable in both lengthwise and widthwise directions of the backreach boom to enable loading of containers from the second platform onto a plurality of over-the-ground vehicles positioned in end-to-end relation in the lengthwise direction of the foundation while the parent crane remains in a fixed position along the foundation.

12. A crane apparatus according to claim 8; wherein the second trolley-hoist-spreader comprises a double trolley that has a main trolley movable backward and forward in a lengthwise direction along the backreach boom and a secondary trolley carried by the main trolley and movable backward and forward in a widthwise direction of the backreach boom.

13. A crane apparatus according to claim 12; further including a container security scanning system disposed on the platform of the crane and that scans the containers while on the platform to determine whether one or more preselected chemical, biological, explosive or nuclear materials are present in the containers.

14. A crane apparatus according to claim 8; further including a container security scanning system disposed on the platform of the crane and that scans the containers while on the platform to determine whether one or more preselected chemical, biological, explosive or nuclear materials are present in the containers.

15. A method for transshipping containers from a vessel moored alongside a foundation to another transportation mode, without ground placement of the containers, using a double boom crane having a first trolley-hoist-spreader movable along an outreach boom and a second trolley-hoist-spreader movable along a backreach boom, the method comprising the steps of:
unloading containers from a vessel moored alongside a foundation using the first trolley-hoist-spreader and placing the containers on a platform of the double boom crane; and
transferring the containers from the platform directly onto another vessel moored alongside the foundation or onto over-the-ground vehicles, without intervening ground placement of the containers, using the second trolley-hoist-spreader.

16. A method according to claim 15; wherein the transferring step comprises transferring the containers from the platform directly onto rail-cars.

17. A method according to claim 15; wherein the transferring step comprises transferring the containers from the platform directly onto trailer-trucks, multi-trailer sets or automated guide vehicles.

18. A method according to claim 15; wherein the transferring step comprises transferring the containers from the platform directly onto another vessel by moving the second trolley-hoist-spreader in both lengthwise and widthwise directions of the backreach boom to load the containers in plural cells onto the other vessel while the double boom crane remains in a fixed position as along the foundation.

19. A method according to claim 15; wherein the transferring step comprises transferring the containers from the platform directly onto over-the-ground vehicles by moving the second trolley-hoist-spreader in both lengthwise and widthwise directions of the backreach boom to load the containers onto two or more over-the-ground vehicles positioned in end-to-end relation in the lengthwise direction of the foundation while the double boom crane remains in a fixed position along the foundation.

20. A method according to claim 15; further including the step of scanning the containers while on the platform to determine whether one or more preselected chemical, biological, explosive or nuclear materials are present in the containers.
